(19) United States
(12) Patent Application Publication
(10) Pub. No.: US 2026/0343266 A1
(43) Pub. Date: Oct. 29, 2026

(54) METHODS, COMMUNICATIONS DEVICES, AND NETWORK INFRASTRUCTURE EQUIPMENT

(71) Applicant: Sony Group Corporation, Tokyo (JP)

(72) Inventors: Martin Warwick BEALE, Basingstoke (GB); Shin Horng WONG, Basingstoke (GB); Naoki KUSASHIMA, Basingstoke (GB)

(73) Assignee: Sony Group Corporation, Tokyo (JP)

(21) Appl. No.: 19/099,056

(22) PCT Filed: Jul. 24, 2023
(86) PCT No.: PCT/EP2023/070480

§ 371 Date: Jan. 28, 2025

(30) Foreign Application Priority Data
Aug. 5, 2022 (EP) 22189132.8

(51) Int. Cl. H04W 24/08; H04W 72/0453; H04W 72/1273; H04W 72/21

(52) U.S. Cl. CPC H04W 24/08; H04W 72/0453; H04W 72/1273; H04W 72/21

(57) ABSTRACT

Methods, communications device, infrastructure equipment and circuitry for performing a sense before transmission (SBT) process before a transmission and adjusting transmission parameters based on the SBT process. A device monitors for transmissions in a monitoring period prior to its own transmission and if it detects one or more transmissions in the monitoring period adjusts the transmission parameters for its own transmission to reduce a level of CLI at another device.

The present application claims the Paris Convention priority of European patent application EP22189132.8, filed 5 Aug. 2022, the contents of which are hereby incorporated by reference.

### BACKGROUND

### Field of Disclosure

The present disclosure relates to a communications device, network infrastructure equipment and methods of operating a communications device to receive data from a wireless communications network.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Modern mobile telecommunication systems, such as those based on the 3GPP defined UMTS and Long Term Evolution (LTE) architecture, are able to support a wider range of services than simple voice and messaging services offered by previous generations of mobile telecommunication systems. For example, with the improved radio interface and enhanced data rates provided by LTE systems, a user is able to enjoy high data rate applications such as mobile video streaming and mobile video conferencing that would previously only have been available via a fixed line data connection. The demand to deploy such networks is therefore strong and the coverage area of these networks, i.e. geographic locations where access to the networks is possible, is expected to continue to increase rapidly.

Wireless communications networks are expected to routinely and efficiently support communications with an ever-increasing range of devices associated with a wide range of data traffic profiles and types. For example, it is expected that wireless communications networks efficiently support communications with devices including reduced complexity devices, machine type communication (MTC) devices, high resolution video displays, virtual reality headsets and so on. Some of these different types of devices may be deployed in very large numbers, for example low complexity devices for supporting the “The Internet of Things”, and may typically be associated with the transmissions of relatively small amounts of data with relatively high latency tolerance. Other types of device, for example supporting high-definition video streaming, may be associated with transmissions of relatively large amounts of data with relatively low latency tolerance. Other types of device, for example used for autonomous vehicle communications and for other critical applications, may be characterised by data that should be transmitted through the network with low latency and high reliability. A single device type might also be associated with different traffic profiles/characteristics depending on the application(s) it is running. For example, different consideration may apply for efficiently supporting data exchange with a smartphone when it is running a video streaming application (high downlink data) as compared to when it is running an Internet browsing application (sporadic uplink and downlink data) or being used for voice communications by an emergency responder in an emergency scenario (data subject to stringent reliability and latency requirements).

In view of this there is a desire for current generation wireless communications networks, for example those referred to as 5G or new radio (NR) systems/new radio access technology (RAT) systems, as well as future iterations/releases of existing systems, to efficiently support connectivity for a wide range of devices associated with different applications and different characteristic data traffic profiles and requirements.

One example of a new service is referred to as Ultra Reliable Low Latency Communications (URLLC) services which, as its name suggests, requires that a data unit or packet be communicated with a high reliability and with a low communications delay. Another example of a new service is enhanced Mobile Broadband (eMBB) services, which are characterised by a high capacity with a requirement to support up to 20 Gb/s. URLLC and eMBB type services therefore represent challenging examples for both LTE type communications systems and 5G/NR communications systems.

5G NR has continuously evolved and the current work plan includes 5G-NR-advanced in which some further enhancements are expected, especially to support new use-cases/scenarios with higher requirements. The desire to support these new use-cases and scenarios gives rise to new challenges for efficiently handling communications in wireless communications systems that need to be addressed.

### SUMMARY OF THE DISCLOSURE

The present disclosure can help address or mitigate at least some of the issues discussed above.

According to a first aspect there is provided a method for a communications device configured to transmit signals to and/or to receive signals from an infrastructure equipment of a wireless communications network via a wireless radio interface provided by the wireless communications network, the method comprising: monitoring, in a monitoring period, for one or more transmissions prior to an uplink transmission to the infrastructure equipment; detecting one or more transmissions in the monitoring period; based on the detected one or more transmissions, determining a value of one or more transmission parameters for the uplink transmission; and transmitting the uplink transmission according to the determined value of the one or more transmission parameters.

According to a second aspect, there is provided a method for an infrastructure equipment configured to transmit signals to and/or to receive signals from a communications device of a wireless communications network via a wireless radio interface provided by the wireless communications network, the method comprising: monitoring, in a monitoring period, for one or more transmissions prior to a downlink transmission to the communications device; detecting one or more transmissions in the monitoring period; based on the detected one or more transmissions, determining a value of one or more transmission parameters for the downlink transmission; and transmitting the downlink transmission according to the determined value of the one or more transmission parameters.

Respective aspects and features of the present disclosure are defined in the appended claims.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and wherein:

FIG. 1 schematically represents some aspects of an LTE-type wireless telecommunication system which may be configured to operate in accordance with certain embodiments of the present disclosure;

FIG. 2 schematically represents some aspects of a new radio access technology (RAT) wireless telecommunications system which may be configured to operate in accordance with certain embodiments of the present disclosure;

FIG. 3 is a schematic block diagram of an example infrastructure equipment and communications device which may be configured to operate in accordance with certain embodiments of the present disclosure;

FIG. 4 schematically illustrates an example of inter-cell cross link interference.

FIG. 5 illustrates an example approach for accounting for inter-cell cross link interference.

FIG. 6 schematically illustrates an example of intra-cell cross link interference.

FIG. 7 illustrates an example division of system bandwidth into dedicated uplink and downlink sub-bands.

FIG. 8 illustrates an example of transmission power leakage.

FIG. 9 illustrates an example of receiver power selectivity.

FIG. 10 illustrates an example of inter sub-band interference.

FIG. 11 illustrates an example of intra sub-band interference.

FIG. 12 illustrates an example of performing a sense before transmission process for various frequency resources according to an example teaching of the present disclosure.

FIG. 13A illustrates an example of timing for a sense before transmission process according to an example teaching of the present disclosure.

FIG. 13B illustrates an example of timing for a sense before transmission process according to an example teaching of the present disclosure.

FIG. 14 illustrates a flow diagram for an example method for a communications device or an infrastructure equipment according to the present disclosure.

### DETAILED DESCRIPTION OF THE EMBODIMENTS

### Long Term Evolution Advanced Radio Access Technology (4G)

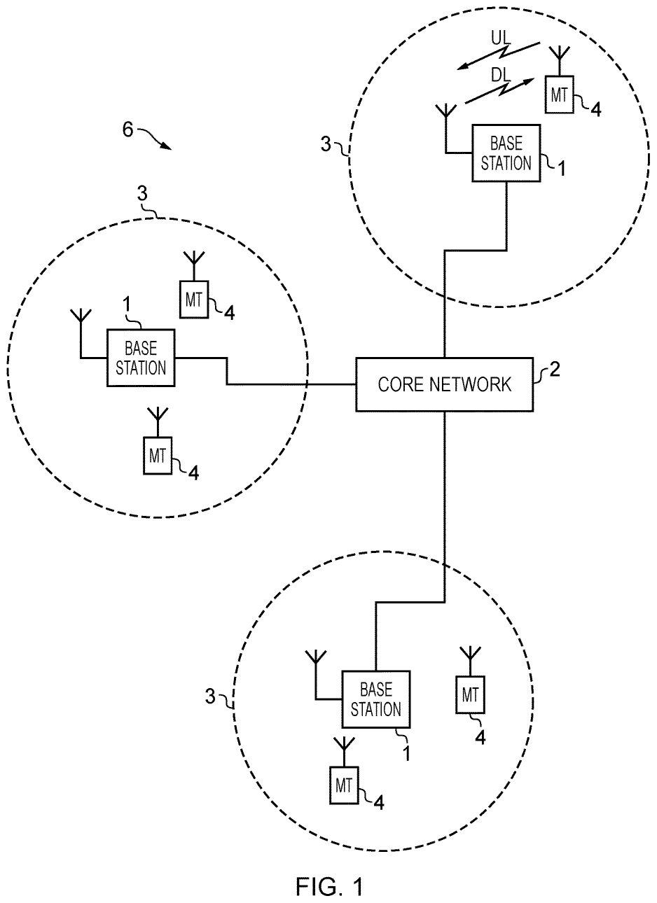

FIG. 1 provides a schematic diagram illustrating some basic functionality of a mobile telecommunications network/system 6 operating generally in accordance with LTE principles, but which may also support other radio access technologies, and which may be adapted to implement embodiments of the disclosure as described herein. Various elements of FIG. 1 and certain aspects of their respective modes of operation are well-known and defined in the relevant standards administered by the 3GPP (RTM) body, and also described in many books on the subject, for example, Holma H. and Toskala A [1]. It will be appreciated that operational aspects of the telecommunications networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 6 includes a plurality of base stations 1 connected to a core network 2. Each base station provides a coverage area 3 (i.e. a cell) within which data can be communicated to and from communications devices 4. Although each base station 1 is shown in FIG. 1 as a single entity, the skilled person will appreciate that some of the functions of the base station may be carried out by disparate, inter-connected elements, such as antennas (or antennae), remote radio heads, amplifiers, etc. Collectively, one or more base stations may form a radio access network.

Data is transmitted from base stations 1 to communications devices or mobile terminals (MT) 4 within their respective coverage areas 3 via a radio downlink. Data is transmitted from communications devices 4 to the base stations 1 via a radio uplink. The core network 2 routes data to and from the communications devices 4 via the respective base stations 1 and provides functions such as authentication, mobility management, charging and so on. The communications or terminal devices 4 may also be referred to as mobile stations, user equipment (UE), user terminal, mobile radio, communications device, and so forth. Services provided by the core network 2 may include connectivity to the internet or to external telephony services. The core network 2 may further track the location of the communications devices 4 so that it can efficiently contact (i.e. page) the communications devices 4 for transmitting downlink data towards the communications devices 4.

Base stations, which are an example of network infrastructure equipment, may also be referred to as transceiver stations, nodeBs, e-nodeBs, eNB, g-nodeBs, gNB and so forth. In this regard different terminology is often associated with different generations of wireless telecommunications systems for elements providing broadly comparable functionality. However, certain embodiments of the disclosure may be equally implemented in different generations of wireless telecommunications systems, and for simplicity certain terminology may be used regardless of the underlying network architecture. That is to say, the use of a specific term in relation to certain example implementations is not intended to indicate these implementations are limited to a certain generation of network that may be most associated with that particular terminology.

### New Radio Access Technology (5G (NR))

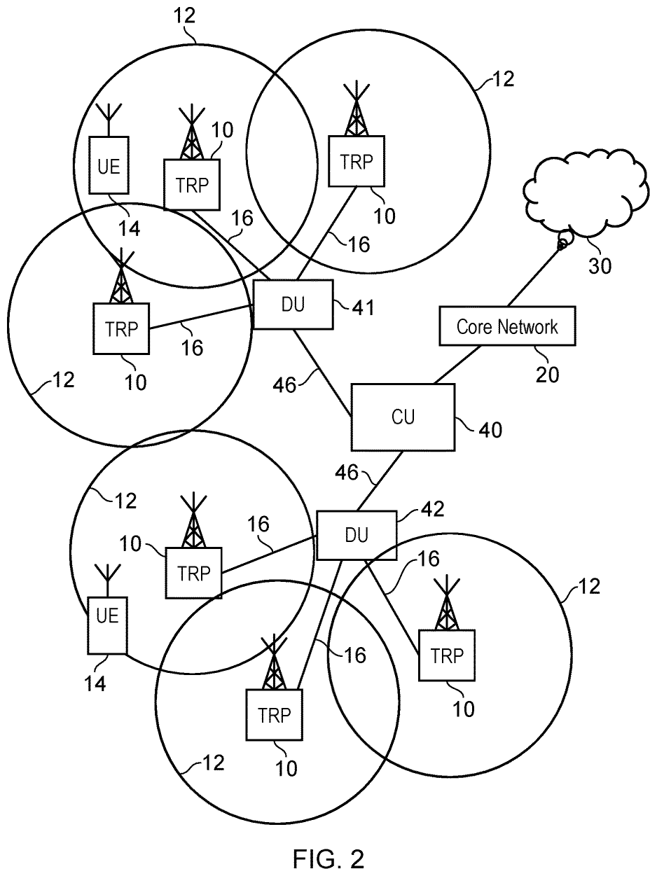

An example configuration of a wireless communications network which uses some of the terminology proposed for and used in NR and 5G is shown in FIG. 2. In FIG. 2 a plurality of transmission and reception points (TRPs) 10 are connected to distributed control units (DUs) 41, 42 by a connection interface represented as a line 16. Each of the TRPs 10 is arranged to transmit and receive signals via a wireless access interface within a radio frequency bandwidth available to the wireless communications network. Thus, within a range for performing radio communications via the wireless access interface, each of the TRPs 10, forms a cell of the wireless communications network as represented by a circle 12. As such, wireless communications devices 14 which are within a radio communications range provided by the cells 12 can transmit and receive signals to and from the TRPs 10 via the wireless access interface. Each of the distributed units 41, 42 are connected to a central unit (CU) 40 (which may be referred to as a controlling node) via an interface 46. The central unit 40 is then connected to the core network 20 which may contain all other functions required to transmit data for communicating to and from the wireless communications devices and the core network 20 may be connected to other networks 30.

The elements of the wireless access network shown in FIG. 2 may operate in a similar way to corresponding elements of an LTE network as described with regard to the example of FIG. 1. It will be appreciated that operational aspects of the telecommunications network represented in FIG. 2, and of other networks discussed herein in accordance with embodiments of the disclosure, which are not specifically described (for example in relation to specific communication protocols and physical channels for communicating between different elements) may be implemented in accordance with any known techniques, for example according to currently used approaches for implementing such operational aspects of wireless telecommunications systems, e.g. in accordance with the relevant standards.

The TRPs 10 of FIG. 2 may in part have a corresponding functionality to a base station or eNodeB of an LTE network. Similarly, the communications devices 14 may have a functionality corresponding to the UE devices 4 known for operation with an LTE network. It will be appreciated therefore that operational aspects of a new RAT network (for example in relation to specific communication protocols and physical channels for communicating between different elements) may be different to those known from LTE or other known mobile telecommunications standards. However, it will also be appreciated that each of the core network component, base stations and communications devices of a new RAT network will be functionally similar to, respectively, the core network component, base stations and communications devices of an LTE wireless communications network.

In terms of broad top-level functionality, the core network 20 connected to the new RAT telecommunications system represented in FIG. 2 may be broadly considered to correspond with the core network 2 represented in FIG. 1, and the respective central units 40 and their associated distributed units/TRPs 10 may be broadly considered to provide functionality corresponding to the base stations 1 of FIG. 1. The term network infrastructure equipment/access node may be used to encompass these elements and more conventional base station type elements of wireless telecommunications systems. Depending on the application at hand the responsibility for scheduling transmissions which are scheduled on the radio interface between the respective distributed units and the communications devices may lie with the controlling node/central unit and/or the distributed units/TRPs. A communications device 14 is represented in FIG. 2 within the coverage area of the first communication cell 12. This communications device 14 may thus exchange signalling with the first central unit 40 in the first communication cell 12 via one of the distributed units/TRPs 10 associated with the first communication cell 12.

It will further be appreciated that FIG. 2 represents merely one example of a proposed architecture for a new RAT based telecommunications system in which approaches in accordance with the principles described herein may be adopted, and the functionality disclosed herein may also be applied in respect of wireless telecommunications systems having different architectures.

Thus, certain embodiments of the disclosure as discussed herein may be implemented in wireless telecommunication systems/networks according to various different architectures, such as the example architectures shown in FIGS. 1 and 2. It will thus be appreciated the specific wireless telecommunications architecture in any given implementation is not of primary significance to the principles described herein. In this regard, certain embodiments of the disclosure may be described generally in the context of communications between network infrastructure equipment/access nodes and a communications device, wherein the specific nature of the network infrastructure equipment/access node and the communications device will depend on the network infrastructure for the implementation at hand. For example, in some scenarios the network infrastructure equipment/access node may comprise a base station, such as an LTE-type base station 1 as shown in FIG. 1 which is adapted to provide functionality in accordance with the principles described herein, and in other examples the network infrastructure equipment may comprise a control unit/controlling node 40 and/or a TRP 10 of the kind shown in FIG. 2 which is adapted to provide functionality in accordance with the principles described herein.

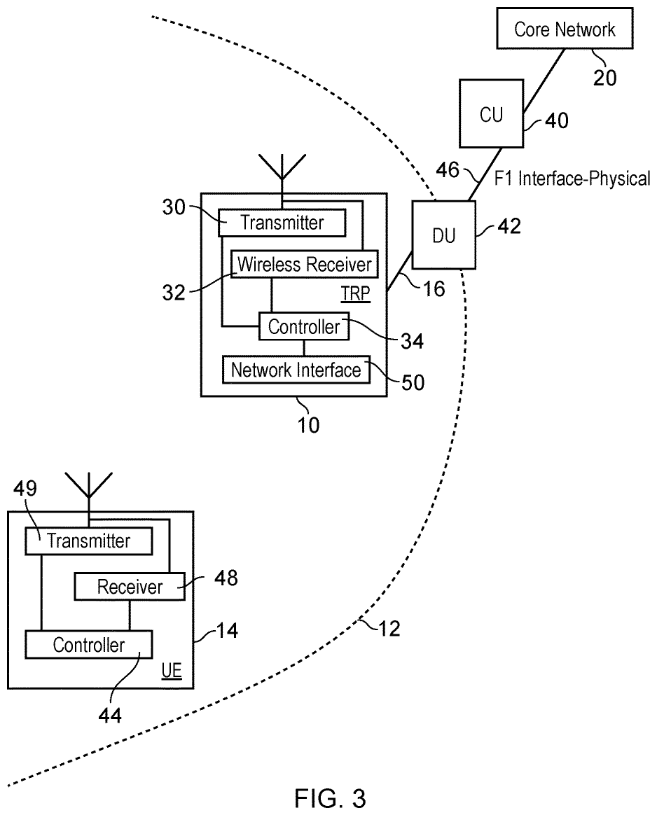

A more detailed diagram of some of the components of the network shown in FIG. 2 is provided by FIG. 3. In FIG. 3, a TRP 10 as shown in FIG. 2 comprises, as a simplified representation, a wireless transmitter 30, a wireless receiver 32 and a controller or controlling processor 34 which may operate to control the transmitter 30 and the wireless receiver 32 to transmit and receive radio signals to one or more UEs 14 within a cell 12 formed by the TRP 10. As shown in FIG. 3, an example UE 14 is shown to include a corresponding transmitter circuit 49, a receiver circuit 48 and a controller circuit 44 which is configured to control the transmitter circuit 49 and the receiver circuit 48 to transmit signals representing uplink data to the wireless communications network via the wireless access interface formed by the TRP 10 and to receive downlink data as signals transmitted by the transmitter circuit 30 and received by the receiver circuit 48 in accordance with the conventional operation.

The transmitter circuits 30, 49 and the receiver circuits 32, 48 (as well as other transmitters, receivers and transceivers described in relation to examples and embodiments of the present disclosure) may include radio frequency filters and amplifiers as well as signal processing components and devices in order to transmit and receive radio signals in accordance for example with the 5G/NR standard. The controller circuits 34, 44 (as well as other controllers described in relation to examples and embodiments of the present disclosure) may be, for example, a microprocessor, a CPU, or a dedicated chipset, etc., configured to carry out instructions which are stored on a computer readable medium, such as a non-volatile memory. The processing steps described herein may be carried out by, for example, a microprocessor in conjunction with a random access memory, operating according to instructions stored on a computer readable medium. The transmitters, the receivers and the controllers are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the infrastructure equipment/TRP/base station as well as the UE/communications device will in general comprise various other elements associated with its operating functionality.

As shown in FIG. 3, the TRP 10 also includes a network interface 50 which connects to the DU 42 via a physical interface 16. The network interface 50 therefore provides a communication link for data and signalling traffic from the TRP 10 via the DU 42 and the CU 40 to the core network 20.

The interface 46 between the DU 42 and the CU 40 is known as the F1 interface which can be a physical or a logical interface. The F1 interface 46 between CU and DU may operate in accordance with specifications 3GPP TS 38.470 and 3GPP TS 38.473, and may be formed from a fibre optic or other wired or wireless high bandwidth connection. In one example the connection 16 from the TRP 10 to the DU 42 is via fibre optic. The connection between a TRP 10 and the core network 20 can be generally referred to as a backhaul, which comprises the interface 16 from the network interface 50 of the TRP 10 to the DU 42 and the F1 interface 46 from the DU 42 to the CU 40.

### Full Duplex Time Division Duplex (FD-TDD)

NR/5G networks can operate using Time Division Duplex (TDD), where an entire frequency band or carrier is switched to either downlink or uplink transmissions for a time period and can be switched to the other of downlink or uplink transmissions at a later time period. Currently, TDD operates in Half Duplex mode (HD-TDD) where the gNB or UE can, at a given time, either transmit or receive packets, but not both at the same time. As wireless networks transition from NR to 5G-Advanced networks, a proposed new feature of such networks is to enhance duplexing operation for TDD by enabling Full Duplex operation in TDD (FD-TDD) [2]. In FD-TDD, a gNB can transmit and receive data to and from the UEs at the same time on the same frequency band or carrier. In addition, a UE can operate either in HD-TDD or FD-TDD mode, depending on its capability. For example, when UEs are only capable of supporting HD-TDD, FD-TDD is achieved at the gNB by scheduling a DL transmission to a first UE and scheduling an UL transmission from a second UE within the same orthogonal frequency division multiplexing (OFDM) symbol (i.e. at the same time). Conversely, when UEs are capable of supporting FD-TDD, FD-TDD is achieved both at the gNB and the UE, where the gNB can simultaneously schedule this UE with DL and UL transmissions within the same OFDM symbol by scheduling the DL and UL transmissions at different frequencies (e.g. physical resource blocks (PRBs)) of the system bandwidth. A UE supporting FD-TDD requires more complex hardware than a UE that only supports HD-TDD. Development of current 5G networks is focused primarily on enabling FD-TDD at the gNB with UEs operating in HD-TDD mode.

Motivations for enhancing duplexing operation for TDD include an improvement in system capacity, reduced latency, and improved uplink coverage. For example, in current HD-TDD systems, OFDM symbols are allocated only for either a DL or UL direction in a semi-static manner. Hence, if one direction experiences less or no data, the spare resources cannot be used in the other direction, or are, at best, under-utilized. However, if resources can be used for DL data and UL data (as in FD-TDD) at the same time, the resource utilization in the system can be improved. Furthermore, in current HD-TDD systems, a UE can receive DL data, but cannot transmit UL data at the same time, which causes delays. If a gNB or UE is allowed to transmit and receive data at the same time (as with FD-TDD), the traffic latency will be improved. In addition, UEs are usually limited in the UL transmissions when located close to the edge of a cell. While the UE coverage at the cell-edge can be improved if more time domain resources are assigned to UL transmissions (e.g. repetitions), if the UL direction is assigned more time resources, fewer time resources can be assigned to the DL direction, which can lead to system imbalance. Enabling FD-TDD would help allow a UE to be assigned more UL time resources when required, without sacrificing DL time resources.

### Inter-Cell Cross Link Interference (CLI)

In NR systems, a slot format (i.e. the allocation of DL and UL OFDM symbols in a slot) can be semi-statically or dynamically configured, where each OFDM symbol (OS) in a slot can be configured as Downlink (DL), Uplink (UL) or Flexible (F). An OFDM symbol that is semi-statically configured to be Flexible can be indicated dynamically as DL, UL or remain as Flexible by a Dynamic Slot Format Indicator (SFI), which is transmitted in a Group Common (GC) Downlink Control Information message (DCI) using DCI Format 2_0, where the CRC of the GC-DCI is masked with SFI-RNTI. Flexible OFDM Symbols that remain Flexible after instruction from the SFI can be changed to a DL symbol or an UL symbol by a DL Grant or an UL Grant respectively. That is, a DL Grant scheduling a PDSCH that overlaps Flexible OFDM Symbols would convert these Flexible OFDM Symbols to DL and similarly an UL Grant scheduling a PUSCH that overlaps Flexible OFDM Symbols would convert these Flexible OFDM Symbols to UL.

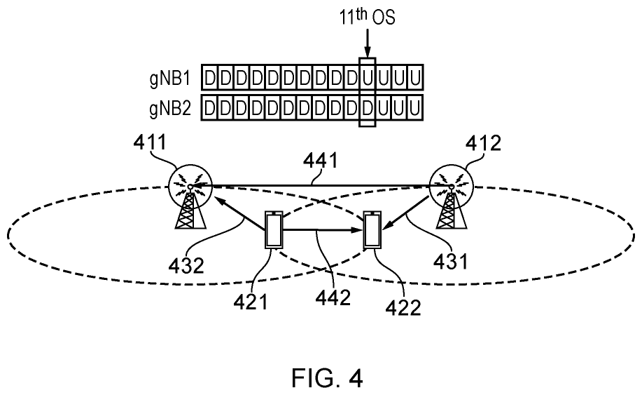

Since each gNB in a network can independently change the configuration of each OFDM symbol, either semi-statically or dynamically, it is possible that in a particular OFDM symbol, one gNB is configured for UL and a neighbour gNB is configured for DL. This causes inter-cell Cross Link Interference (CLI) among the conflicting gNBs. Inter-cell CLI occurs when a UE's UL transmission interferes with a DL reception by another UE in another cell, or when a gNB's DL transmission interferes with an UL reception by another gNB. That is, inter-cell CLI is caused by non-aligned (conflicting) slot formats among neighbouring cells. An example is shown in FIG. 4, where gNB1 411 and gNB2 412 have synchronised slots. At a given slot, gNB1's 411 slot format={D, D, D, D, D, D, D, D, D, D, U, U, U, U} whilst gNB2's 412 slot format={D, D, D, D, D, D, D, D, D, D, D, U, U, U}, where ‘D’ indicates DL and ‘U’ indicates UL. Inter-cell CLI occurs during the 11^{th} OFDM symbol of the slot, where gNB1 411 is performing UL whilst gNB2 412 is performing DL. Specifically, inter-cell CLI 441 occurs between gNB1 411 & gNB2 412, where gNB2's 412 DL transmission 431 interferes with gNB1's 411 UL reception 432. CLI 442 also occurs between UE1 421 & UE2 422, where UE1's 421 UL transmission 432 interferes with UE2's 422 DL reception 431.

Some legacy implementations attempt to reduce inter-cell CLI in TDD networks caused by flexible and dynamic slot format configurations. Two CLI measurement reports to manage and coordinate the scheduling among neighbouring gNBs include: sounding reference signal (SRS) reference signal received power (RSRP) and CLI received signal strength indicator (RSSI). In SRS-RSRP, a linear average of the power contribution of an SRS transmitted by a UE is measured by a UE in a neighbour cell. This is measured over the configured resource elements within the considered measurement frequency bandwidth, in the time resources in the configured measurement occasions. In CLI-RSSI, a linear average of the total received power observed is measured only at certain OFDM symbols of the measurement time resource(s), in the measurement bandwidth, over the configured resource elements for measurement by a UE.

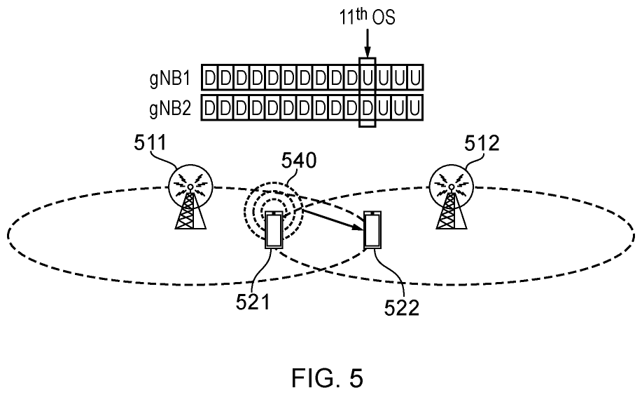

Both SRS-RSRP and CLI-RSSI are RRC measurements and are performed by a UE, for use in mitigating against UE to UE inter-cell CLI. For SRS-RSRP, an aggressor UE (i.e. a UE whose UL transmissions cause interference at another UE in a neighbouring cell) would transmit an SRS in the uplink and a victim UE (i.e. a UE that experiences interference due to an UL transmission from the UE in the neighbouring cell) in a neighbour cell would be configured with a measurement configuration including the aggressor UE's SRS parameters, in order to allow the interference from the aggressor UE to be measured. An example is shown in FIG. 5 where, at a particular slot, the 11^{th} OS (OFDM symbol) of gNB1 511 and gNB2 512 causes inter-cell CLI. Here, gNB1 511 has configured UE1 521, the aggressor UE, to transmit an SRS 540 and gNB2 512 has configured UE2 522, the victim UE, to measure that SRS 540. UE2 522 is provided with UE1's 521 SRS configured parameters, e.g. RS sequence used, frequency resource, frequency transmission comb structure & time resources, so that UE2 522 can measure the SRS 540. In general, a UE can be configured to monitor 32 different SRSs, at a maximum rate of 8 SRSs per slot.

For CLI-RSSI measurements, the UE measures the total received power, i.e. signal and interference, following a configured periodicity, start & end OFDM symbols of a slot, and a set of frequency Resource Blocks (RBs). Since SRS-RSRP measures a transmission by a specific UE, the network can target a specific aggressor UE to reduce its transmission power and in some cases not schedule the aggressor UE at the same time as a victim UE that reports a high SRS-RSRP measurement. In contrast, CLI-RSSI cannot be used to identify a specific aggressor UE's transmission, but CLI-RSSI does provide an overall estimate of the inter-cell CLI experienced by the victim UE.

### Intra-Cell Cross Link Interference (CLI)

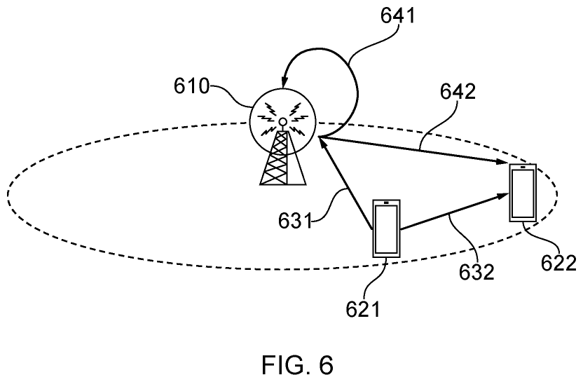

In addition to inter-cell CLI, FD-TDD also suffers from intra-cell CLI at the gNB and at the UE. An example is shown in FIG. 6, where a gNB 610 is capable of FD-TDD and is simultaneously receiving UL transmission 631 from UE1 621 and transmitting a DL transmission 642 to UE2 622. At the gNB 610, intra-cell CLI is caused by the DL transmission 642 at the gNB's transmitter self-interfering 641 with its own receiver that is trying to decode UL signals 631. At UE2 622, intra-cell CLI 632 is caused by an aggressor UE, e.g. UE1 621, transmitting in the UL 631, whilst a victim UE, e.g. UE2 622, is receiving a DL signal 642.

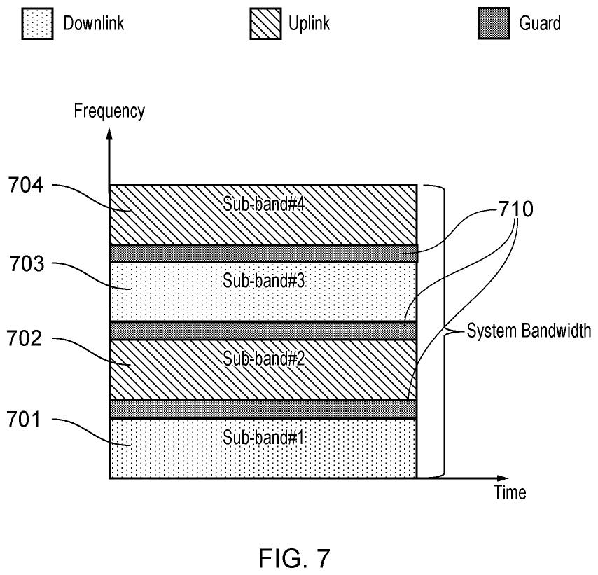

The intra-cell CLI at the gNB due to self-interference can be significant, as the DL transmission can in some cases be over 100 dB more powerful than the UL reception. Accordingly, complex RF hardware and interference cancellation are required to isolate this self-interference. In order to reduce self-interference at the gNB, one possibility is to divide the system (i.e. UE/gNB) bandwidth into non-overlapping sub-bands 701-704, as shown in FIG. 7, where simultaneous DL and UL transmissions occur in different sub-bands 701-704, i.e. in different sets of frequency Resource Blocks (RB). While FIG. 7 shows the system bandwidth as being divided into four sub-bands, substantially any number of sub-bands could be used. For example, the system bandwidth may be divided into three sub-bands, which may include two downlink sub-bands 701, 703 and one uplink sub-band 702, however other sub-band arrangements are envisioned.

To reduce leakage from one sub-band 701-704 to another, a guard sub-band 710 may be configured between UL and DL sub-bands 701-704. An example is shown in FIG. 7, where a TDD system bandwidth is divided into 4 sub-bands 701, 702, 703, 704: Sub-band #1 701, Sub-band #2 702, Sub-band #3 703 and Sub-band #4 704 such that Sub-band #1 701 and Sub-band #3 703 are used for DL transmissions whilst Sub-band #2 702 and Sub-band #4 704 are used for UL transmissions. Guard sub-bands 710 are configured between UL Sub-band #4 704 and DL Sub-band #3 703, between DL Sub-band #3 703 and UL Sub-band #2 702 and between UL Sub-band #2 702 and DL Sub-band #1 701. The arrangement of sub-bands 701-704 shown in FIG. 7 is just one possible arrangement of the sub-bands and other arrangements are possible, and guard bands may be used in substantially any sub-band arrangement.

### Inter Sub-Band Interference

Although a transmission is typically scheduled within a specific frequency channel (or sub-band), i.e. a specific set of RBs, transmission power can leak out to other channels. This occurs because channel filters are not perfect, and as such the roll-off of the filter will cause power to leak into channels adjacent to the intended specific frequency channel. While the following discussion uses the term “channel”, the term “sub-band”, such as the sub-bands shown in FIG. 7, may be used instead.

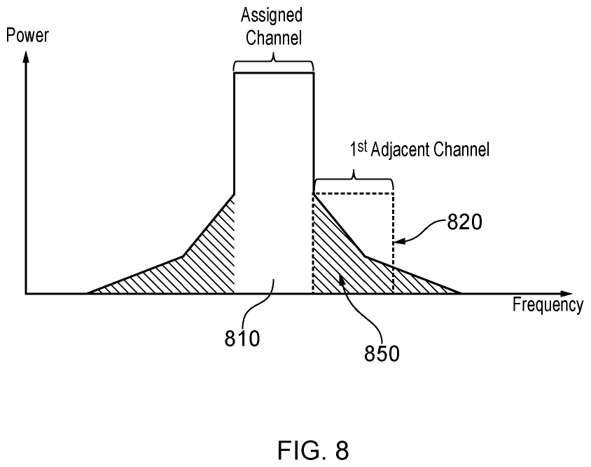

An example of transmission generating adjacent channel leakage is shown in FIG. 8. Here, the wanted transmission (Tx) power is the transmission power in the selected frequency band (i.e. the assigned channel 810). Due to roll-off of the transmission filter and nonlinearities in components of the transmitter, some transmission power is leaked into adjacent channels (including an adjacent channel 820), as shown in FIG. 8. The ratio of the power within the assigned frequency channel 810 to the power in the adjacent channel 820 is the Adjacent Channel Leakage Ratio (ACLR). The leakage power 850 will cause interference at a receiver that is receiving the signal in the adjacent channels 820.

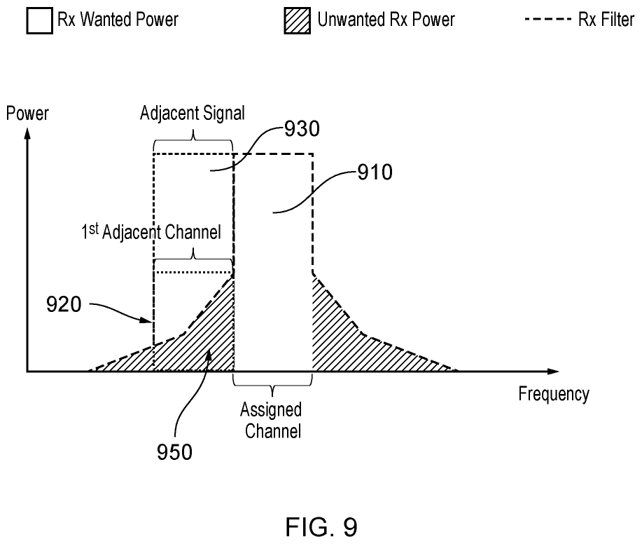

Similarly, a receiver's filter is also not perfect and will receive unwanted power from adjacent channels due to its own filter roll-off. An example of filter roll-off at a receiver is shown in FIG. 9. Here, a receiver is configured to receive transmissions in an assigned channel 910, however the imperfect nature of the receiver filter means that some transmission power 950 can be received in adjacent channels 920. Therefore, if a signal 930 is transmitted on an adjacent channel 920, the receiver will inadvertently receive the adjacent signal 930 in the adjacent channel 920, to an extent. The ratio of the received power in the assigned frequency channel 910 to the received power 950 in the adjacent channel 920 is the Adjacent Channel Selectivity (ACS).

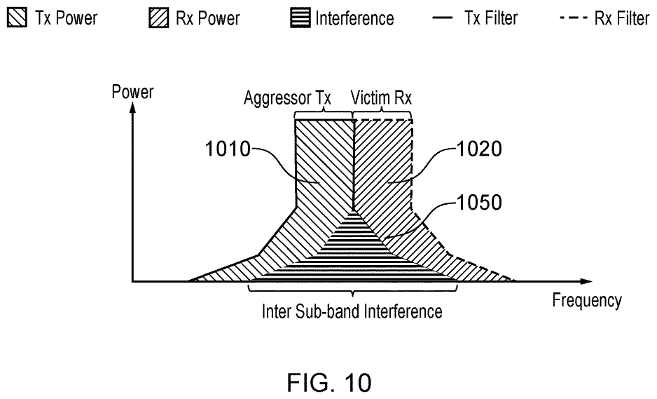

The combination of the ACL from the transmitter and the ACS of a receiver will lead to adjacent channel interference (ACI), otherwise known as inter-sub-band interference, at the receiver. An example is shown in FIG. 10, where an aggressor transmits a signal 1010 in an adjacent channel at a lower frequency than the victim's receiving 1020 channel. The interference 1050 caused by the aggressor's transmission includes the ACL of the aggressor's transmitting filter and the ACS of the victim's receiving filter. In other words, the receiver will experience interference 1050 in the ACI frequency range shown in FIG. 10.

As such, due to adjacent channel interference (ACI), cross link interference (CLI) will still occur despite the use of different sub-bands 701-704 for DL and UL transmissions in an FD-TDD cell. The proposed SRS-RSRP and CLI-RSSI measurements specified for inter-cell CLI assume that an aggressor and a victim transmit and receive in the same frequency channel. That is, the measurements for SRS-RSRP and CLI-RSSI at a victim UE are performed in the same frequency channel as the aggressor's frequency channel. These approaches therefore do not take into account ACI and the use of sub-bands 701-704 to provide information for the scheduler to mitigate against intra-cell CLI.

### Intra Sub-Band Interference

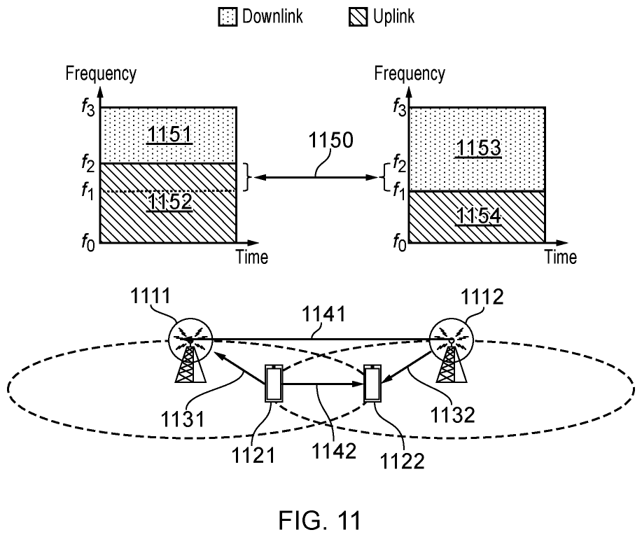

Intra sub-band interference can occur when the sub-band configurations among gNBs are not aligned in the frequency domain. Here, CLI may occur in the overlapping frequencies of inter-cell sub-bands. An example is shown in FIG. 11, where gNB1's 1111 system bandwidth is divided into UL sub-band UL-SB #1 1152 occupying f₀ to f₂ and DL sub-band DL-SB #1 1151 occupying f₂ to f₃, whilst gNB2's 1112 system bandwidth is divided into UL sub-band UL-SB #2 1154 occupying f₀ to f₁ and DL sub-band DL-SB #2 1153 occupying f₁ to f₃. The non-aligned sub-band configurations 1150 cause UL-SB #1 1152 to overlap with DL-SB #2 1153, thereby causing intra sub-band CLI within the overlapping frequencies f₁ to f₂. In this example, intra sub-band CLI 1141 occurs at gNB1 1111 due to gNB2's 1112 DL transmission 1132 within f₁ to f₂ in DL-SB #2 1153 interfering with gNB1's 1111 UL reception 1131 from UE1 1121 within f₁ to f₂ in UL-SB #1 1152. In addition, intra sub-band CLI 1142 occurs at UE2 1122 due to UE1's 1121 UL transmission 1131 within f₁ to f₂ in UL-SB #1 1152 interfering with UE2's 1122 DL reception 1132 within f₁ to f₂ in DL-SB #2 1153.

### Sense Before Transmission (SBT)

In unlicensed frequency spectrums, two or more systems may operate in the same frequency band, and as such their transmissions can interfere with one another, in particular when different systems are used (e.g. Wi-Fi and 5G). Currently, when operating in an unlicensed frequency spectrum, UEs use a Listen Before Talk (LBT) protocol in order to reduce interference levels. In LBT, a UE that wishes to transmit a packet will monitor (i.e. listen to) the frequency band for signals above a predetermined energy level threshold. If the UE does not detect any transmissions above the predetermined energy level threshold, the UE may then proceed with its own transmission. However, if the UE does detect a transmission above the predetermined energy level threshold, the UE does not proceed with its own transmission.

LBT can be used to manage CLI for FD-TDD networks. However, one drawback of existing LBT systems in FD-TDD, is that LBT significantly reduces the throughput of the device. In particular, modern networks may include a large number of gNBs and as such if a UE is configured not to transmit when detecting a signal from a gNB, this can create significant delays in uplink transmissions, thereby increasing latency and reducing throughput. As such, existing LBT approaches are unsuitable for modern FD-TDD networks such as those described above.

The present disclosure provides examples of using a sense before transmission (SBT) technique to minimise levels of CLI in a FD-TDD network, without causing increases in latency or reductions in throughput. When utilising SBT, a node (i.e. a UE or gNB) is able to schedule multiple sets of transmission parameter values for a transmission. In the following discussion, the SBT process is described primarily as being performed by a UE, however it should be appreciated that, unless explicitly stated, the following techniques may also be performed by a gNB in an analogous manner. In the SBT process, the UE senses (i.e. monitors) for a downlink transmission from a neighbouring gNB (i.e. in a neighbouring cell) and determines whether any detected downlink transmissions meet a particular threshold. For example, the UE may measure a reception energy of the detected downlink transmission and determine whether this is above a predetermined threshold. If the reception energy is at or below the predetermined threshold, the UE may use a first set of transmission parameter values (i.e. a first set of values for particular transmission parameters). However, if the reception energy is above the predetermined threshold, the UE may use a second set of transmission parameter values (i.e. a second set of values for the particular transmission parameters). The second set of transmission parameter values may be configured to, for example, reduce CLI between the UE and another UE in the neighbouring cell, and/or the second set of transmission parameter values may be configured to be more robust (i.e. more reliably decodable by a serving gNB) in order to reduce the impact of CLI at the serving gNB. Accordingly, the SBT process of the present disclosure is able to reduce the impact of CLI by allowing a UE to adjust its uplink transmission, and without causing increases in latency or reductions in throughput, as the UE is able to transmit even in the presence of other transmissions.

In the measurement process (i.e. the sensing/monitoring step) of the SBT operation a UE may determine whether a channel or sub-band (i.e. a set of frequency resources) are idle or busy (in a similar manner to traditional LBT processes) by detecting a reception energy of any transmissions in said channel or sub-band. This measurement process can be performed in substantially any time slots. For example, existing LBT measurements are limited to specified slot durations (e.g. CCA slot durations of 9, 16 or 25 μs), however the SBT measurement process of the present disclosure may have substantially any duration, i.e. one or more OFDM symbols.

As discussed above, in the SBT process of the present disclosure a UE is able to select transmission parameter values for an uplink transmission based on the SBT measurement step. For example, the UE may store a first set of transmission parameter values to be used when a UE passes the SBT test, that is when no signals are detected or when the signals do not exceed the predetermined threshold, and a second set of transmission parameter values to be used when the UE fails the SBT test, that is the UE detects a signal, or detects signals exceeding the predetermined threshold. Even though the CLI occurs at a serving gNB, detection of signals at the UE may be indicative that there could be a CLI issue at the gNB.

In some examples, the transmission parameters may include a modulation and coding scheme (MCS). For example, a UE's second transmission parameter values may have a more robust (i.e. more reliable) MCS than the first set of parameters. This recognises that when a UE fails the SBT test, then there is an ongoing transmission that may cause CLI at a gNB and/or the UE's transmission may cause CLI with that ongoing transmission, and hence the second set of transmission parameter values that are more robust would have a higher probability of being decoded at the receiving node (i.e. receiving gNB or node). The second set of transmission parameter values can be viewed as fallback transmission parameter values and so may have a lower throughput than the first set of transmission parameter values.

This example may be understood with reference to FIG. 11. In this example, UE1 1121 is the device that wishes to transmit and hence performs SBT. UE1 1121 will transmit to gNB1 1111. UE1's UL transmission would potentially be prone to CLI 1141 at gNB1 1111 due to the DL transmission 1132 from gNB2 1112 to UE2 1122. UE1's 1121 UL transmission 1131 could also potentially cause CLI 1142 with UE2's 1122 DL reception 1132 from gNB2 1112. Hence, UE1 1121 listens for transmissions before UE1 1121 transmits the UL signal 1131. If UE1 1121 detects a transmission, it uses a more robust transmission format. UE1's 1121 transmission will therefore be decoded more reliably at gNB1 1111 in the presence of the DL CLI 1141 from gNB2 1112 at gNB1 1111. However, UE1's 1121 transmission may still impact UE2's 1122 DL reception 1132 due to UL CLI 1142.

In some examples, the transmission parameters may additionally or alternatively include transmission power. That is, the second set of transmission parameter values may include a lower transmission power than the first set of transmission parameter values. A lower transmission power is particularly applicable when the goal of the system is to reduce UL CLI 1142 in the neighbour cell. With reference to FIG. 11, a lower transmission power would mean that if the SBT process at UE1 1121 detected the transmission 1132 from gNB2 1112, UE1 1121 would transmit 1131 with a lower transmission power such that UE1's 1121 UL transmission 1131 would not interfere 1142 with UE2's 1122 DL reception 1132.

In some examples, the transmission parameters may additionally or alternatively include a set of physical resources applied to the transmission. The set of physical resources can include frequency domain resources, for example expressed as the number and location of physical resource blocks applied to a transmission. Referring to FIG. 11, if the DL sub-band 1151, 1153 and UL sub-band 1152, 1154 locations were fixed for gNB1 1111 and gNB2 1112, the physical resources of the second set of transmission parameter values may be the portion of UE1's 1121 physical resources that occupy the non-overlapping region in the frequency domain. For example, if the SBT process at UE1 1121 detects a DL transmission 1132 from gNB2 1112 in the frequency range f₁ to f₂ and if UE1 1121 had assigned physical resources f₀ to f₂ for its UL transmission 1131, UE1 1121 may then transmit only in the frequency range f₀ to f₁. In this manner, UE1's 1121 UL transmission 1131 would not cause interference 1142 with UE2's 1122 DL reception 1132 and gNB2's 1112 DL transmission 1132 would not cause interference 1141 with gNB1's 1111 UL reception 1131.

In some examples, the transmission parameters may additionally or alternatively include a set of reference symbols applied to the transmission. For example, the second set of transmission parameter values may include additional demodulation reference signals (DMRS) not present in the first set of transmission parameter values. Applying additional DMRS to a UE's transmission allows a gNB to derive a more accurate channel estimate in order to more robustly and reliably decode the UE's transmission.

Additionally or alternatively, the reference symbols may be reference symbols that enable interference cancellation at a receiving device that is subject to CLI. For example, referring to FIG. 11, if UE1's 1121 SBT process detects transmissions 1132 from gNB2 1112, UE1 1121 may include additional reference symbols in its UL transmission 1131. These extra reference symbols allow gNB1 1111 to differentiate between the unwanted DL transmission 1132 from gNB2 1112 and the wanted UL transmission 1131 from UE1 1121. gNB1 1111 can then cancel the interference 1141 from gNB2 1112 and decode the UL transmission 1131 from UE1 1121. Similarly, UE2 1122 may use UE1's 1121 additional reference symbols to cancel the interference 1142 from the transmission 1131 from UE1 1121 and then more robustly decode the DL transmission 1132 from gNB2 1112.

These additional reference symbols for interference cancellation may be included in the transmission parameter values based on the SBT result as in cases where there is no CLI, the resources that would have been used for the additional reference symbols can be used for transmitting data. Thus, this approach is more resource efficient. In some cases, for effective interference cancellation, the nodes performing the interference cancellation may need additional information. For example, referring back to FIG. 11, for gNB1 1111 to cancel the DL-CLI 1141 due to the DL transmission 1132 from gNB2 1112, gNB1 1111 may need to know the reference symbols used by gNB2 1112. Hence, gNB2 1112 may signal the reference symbols used to gNB1 1111, for example via a backhaul interface.

In some examples, the transmission parameters may additionally or alternatively include a number of layers for a Multiple Input Multiple Output (MIMO) transmission, or a maximum number of layers for a MIMO transmission. That is, the second set of transmission parameter values may include a smaller number of layers for MIMO transmission parameters than the first set of transmission parameter values. A lower number of MIMO layers is applicable when there is CLI since a transmission with a lower number of MIMO layers is more robust to interference (e.g. CLI) than a transmission with a higher number of MIMO layers. Furthermore, if the gNB has limited signal processing resources, it may be beneficial for the gNB to use those signalling processing for CLI cancellation rather than for processing multiple layers when there is CLI.

In some examples, the transmission parameters may additionally or alternatively include a number of code block groups (CBGs). For example, a first set of transmission parameters may include more code block groups than the second set of transmission parameters. A smaller number of code block groups may be more robustly decoded than a larger number of code block groups due to the lower code rate associated with a smaller amount of data transmitted within an amount of physical resources.

As discussed above, a node (i.e. a UE or gNB) may have multiple sets of transmission parameter values indicating values for transmission parameters for use based on an SBT result (e.g. a first set of transmission parameter values and a second set of transmission parameter values). These sets of transmission parameter values may include various combinations of the above-discussed transmission parameters, or indeed other transmission parameters not explicitly discussed herein. For example, the second set of transmission parameter values may comprise an MCS and a transmission power, where the MCS value of the second set of transmission parameter values is more robust compared to the first set of transmission parameter values and the transmission power of the second set of transmission parameter values is lower than the first set of transmission parameter values.

This recognises that when a node (e.g. gNB or UE) fails the SBT test, then there is an ongoing transmission that may cause CLI to that node and/or the node's transmission may cause CLI to that ongoing transmission. The use of a more robust MCS for a transmission increases the probability of the transmission being successfully decoded at its intended destination. In contrast, reducing the transmission power reduces the probability of the transmission being successfully decoded at its intended destination, but also reduces the level of CLI at other devices. Accordingly, a transmission with the second set of transmission parameter values may have approximately the same probability of being successfully decoded at a node, while also reducing CLI. The second set of transmission parameter values can be viewed as fallback transmission parameter values as they may have a lower throughput than the first set of transmission parameter values.

Operation of this example is described with reference to FIG. 11. In this example, UE1 1121 is the device that wishes to transmit 1131 and hence performs SBT. UE1 1121 will transmit 1131 to gNB1 1111. UE1's 1121 UL transmission 1131 would potentially be prone to CLI 1141 at gNB1 1111 due to the DL transmission 1132 from gNB2 1112 to UE2 1122. UE1's 1121 UL transmission 1131 could also potentially cause CLI 1142 with UE2's 1122 DL reception 1132 from gNB2 1112. Hence, UE1 1121 senses for transmissions before UE1 1121 itself transmits and if UE1 1121 detects a transmission (above a threshold), it may use a more robust transmission format and a lower transmit power. Since UE1 1121 lowers the transmit power of the more robust transmission format, UE1's 1121 transmission 1131 will cause less UL CLI 1142 at UE2 1122 but the reliability of UE1's 1121 transmission 1131 at gNB1 1111 may be approximately equal to the case when the first set of transmission parameters is used (the effects of the lower transmission power and more robust transmission format may cancel out).

In the uplink, this technique is applicable to both scheduled and non-scheduled transmissions. Scheduled transmissions may occur on a dynamically allocated PUSCH, a PUSCH that is semi-statically allocated via a configured grant process (CG-PUSCH), a Physical Uplink Control Channel (PUCCH) or on a transmission of Sounding Reference Signals (SRS). The examples described above are applicable at least for dynamically allocated PUSCH and CG-PUSCH.

For PUCCH, the transmission parameters may include a PUCCH format. In an example, the second set of transmission parameters may include a more robust PUCCH format. For example, referring to FIG. 11, if UE1's 1121 SBT process detects transmissions 1132 from gNB2 1112, UE1 1121 may transmit PUCCH using a more robust PUCCH format in its UL transmission 1131. The more robust PUCCH may be more easily decoded at gNB1 1111 in the presence of the DL CLI 1141 from gNB2 1112.

In some examples for PUCCH, the transmission parameters may include a power level. Furthermore, for PUCCH, the transmission parameters may include frequency resources. The first and second sets of transmission parameters may differ in their support of frequency hopping. For example, the first set of transmission parameters may comprise frequency hopped resources while the second set of transmission parameters comprises PUCCH resources that do not support frequency hopping. If at least one of the frequency resources of the frequency hopped resources in the first set of transmission parameters were potentially subject to CLI, as determined by the SBT process, the UE would use the non-hopped resources of the second set of transmission parameters that were not subject to CLI. Alternatively, if the first set of transmission parameters comprised frequency resources that do not support frequency hopping, the second set of transmission parameters may include frequency hopped resources. If the SBT process determined that the first set of non-hopped resources were potentially subject to CLI, the UE would apply the second set of transmission parameters that support frequency hopping, since the frequency hopped resources may be more robust due to the additional diversity available from the frequency-hopped resources.

For SRS, the transmission parameters may include a configuration of the SRS. That is, the UE can be configured with multiple SRS configurations. The first set of transmission parameters may include a first SRS configuration and the second set of transmission parameters may include a second SRS configuration. For example, the first SRS configuration and the second SRS configuration may differ in terms of the frequency span over which SRS is to be transmitted.

For non-scheduled uplink transmissions, the techniques of the present disclosure are applicable to the Physical Random Access Channel (PRACH). That is, the UE may perform an SBT process before PRACH transmission. The UE may determine one or more PRACH resources that it wishes to use for transmission prior to performing the SBT process. The UE may then perform the SBT process on those resources. If the UE does not detect another transmission on those PRACH resources, the UE transmits PRACH according to the first set of transmission parameters, otherwise the UE transmits PRACH according to the second set of transmission parameters.

The gNB may receive the PRACH based on an SBT process and according to two sets of transmission parameters. If the SBT process indicated that there were other transmissions, the gNB would decode according to the second set of transmission parameters, for example based on longer PRACH formats, whereas if the SBT process indicated that there were no other transmissions, the gNB would decode according to the first set of transmission parameters.

For PRACH, the transmission parameters may include a PRACH format. PRACH formats may differ in terms of the length of the PRACH in time and the length of the sequence that is used to generate the PRACH. If the SBT process detects another transmission, the UE would use the PRACH format from the first set of transmission parameters, otherwise it would use the PRACH format from the second set of transmission parameters. For PRACH, the transmission parameters may additionally or alternatively include a power ramping step size. The power ramping step size controls the amount by which the PRACH power is increased between re-transmissions of the PRACH. For example, the second set of transmission parameters may include a larger PRACH power ramping step size than for the first set of transmission parameters. A larger power ramping step size may be applicable when there is CLI as it would allow the PRACH to be robustly received sooner than for the case of a smaller power ramping step size. In other words, if some resources are subject to CLI, it is important to react quickly to that increase in CLI by more rapidly increasing the power of subsequent repeats of the PRACH transmission.

In the downlink, as well as being applicable for a Physical Downlink Shared Channel (PDSCH) and semi-persistent scheduling (SPS) PDSCH, this technique is also applicable for the Physical Downlink Control Channel (PDCCH). At the communications device, the PDCCH is received by blind decoding a set of PDCCH candidates. The candidates within the set of PDCCH candidates can differ in terms of aggregation level, where the aggregation level defines the amount of physical resource applied to the candidate. In an example of this technique, the first set of transmission parameters can include a first set of PDCCH candidates, and the second set of transmission parameters can include a second set of PDCCH candidates, where the second set of PDCCH candidates includes more candidates with higher aggregation levels. Alternatively, the frequency resources applied to the second set of candidates may differ from the frequency resources applied to the first set of candidates. Alternatively, the control resource set (CORESET) for the PDCCH may differ between the first set of transmission parameters and the second set of transmission parameters. The two sets of candidates may include some common candidates to enable fallback operation (e.g. the gNB might choose a common candidate if it suspected that there was a mismatch between the SBT status at the gNB and UE). If the SBT process at the gNB indicated the presence of other transmissions, the gNB may transmit PDCCH using a candidate from the (more robust) second set of candidates, otherwise the gNB may transmit PDCCH using a candidate from the first set of candidates. Alterniatvely or additionally, the first set of PDCCH candidate may use a first DCI format and the second set of PDCCH candidate uses a second DCI format, for example, the first DCI format may be DCI Format 1_1 or 1_2 whilst the second DCI format may be DCI Format 1_0 (also known as fallback DCI which is smaller and more robust). Similarly, if the SBT process at the UE indicated the presence of other transmissions, the UE would receive PDCCH by blind decoding candidates from the (more robust) second set of candidates, otherwise the UE would receive PDCCH by blind decoding candidates from the first set of candidates.

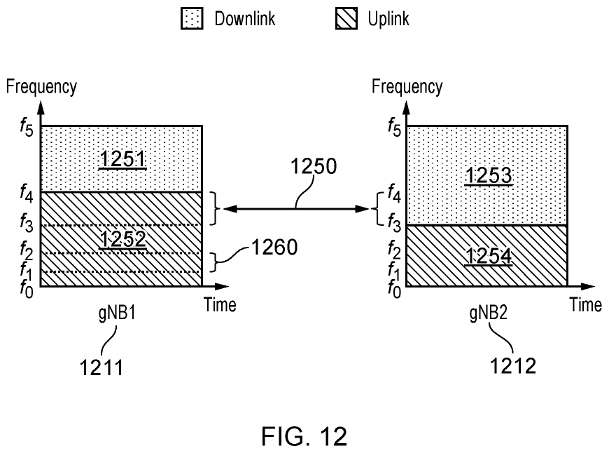

The SBT process itself will be described below. As discussed above, in the SBT process a node senses for a transmission from one or more neighbouring nodes. A node may do so by monitoring specific frequency resources. For example, a node device that wishes to send a transmission only performs SBT on the frequency resources that it is intending to use. This example may be understood with reference to FIG. 12. FIG. 12 illustrates a sub-band format for gNB1 1211 and gNB2 1212, where the sub-band format for gNB1 1211 includes an uplink sub-band from frequency f₀ to f₄, and a downlink sub-band from frequency f₄ to f₅. The sub-band format for gNB2 1212 includes an uplink sub-band from frequency f₀ to f₃, and a downlink sub-band from frequency f₃ to f₅. Due to overlap between the uplink and downlink sub-bands at frequencies f₃ to f₄, CLI 1250 may occur at gNB1 1211 for transmissions in this frequency range, in a similar manner to that previously described with reference to FIG. 11.

In the present example, a UE may be scheduled to transmit in RBs occupying frequencies f₂ to f₄. In other words, the first set of transmission parameter values may have a value for the frequency resources of f₂ to f₄. The UE may also have second (fallback) transmission parameter values with a value for the frequency resources of f₁ to f₂, such that when using the second set of transmission parameter values the UE transmits using fallback RBs f₁ to f₂. Therefore, the UE may perform SBT in a number of possible ways. For example, the UE may monitor all of the frequencies the UE intends (or may intend) to use (i.e. frequency resources associated with the UE's transmission), such that the UE monitors the frequency resources for the first set of transmission parameter values (i.e. f₂ to f₄) and may in some cases also monitor the frequency resources for the second set of transmission parameter values (i.e. f₁ to f₂). The UE may therefore not monitor frequency resources f₀ to f₁. However, in some examples, the UE may also monitor frequency resources in neighbouring sub-bands where inter sub-band interference may occur, such as in the manner described in relation to FIGS. 8-10.

In some examples, the device only performs SBT on frequency resources where CLI is possible. Returning to the examples of FIG. 12, the UE may perform SBT for frequency resources that both fall within the frequency resources associated with the transmission (i.e. included in the first set of transmission parameter values or within any of the UE's sets of transmission parameter values) and are frequency resources where CLI could occur (e.g. where a neighbouring gNB uses those frequencies as part of a DL sub-band or as part of a flexible sub-band). In the example of FIG. 12, the UE may therefore only perform SBT for frequencies f₅ to f₄, but may in some cases also monitor frequency resources in neighbouring sub-bands where inter sub-band interference may occur.

Various actions may be taken to allow a node to only monitor frequency resources it intends to use and which may be subject to CLI. For example, returning to FIG. 12, gNB1 1211 may signal to the UE the sub-band usage characteristics (e.g. which regions of the carrier are used for UL, DL and flexible) of gNB2 1212. This information may have been provided to gNB1 1211 by gNB2 1212 (e.g. via a backhaul interface). This information can be used by a UE within the serving cell (the cell provided by gNB1 1211) to determine the frequency resources on which SBT should be performed.

Additionally or alternatively, a node UE may attempt to infer the sub-band usage characteristics (e.g. which regions of the carrier are used for UL, DL and flexible) of a neighbour node during the SBT process. For example, returning to FIG. 11, UE1 1121 may attempt to infer the sub-band usage characteristics of gNB2 1112 during the SBT process. In this example, DL CLI 1141 only occurs at gNB1 1111 when gNB2 1112 is transmitting 1132 in the DL. Similarly, UL CLI 1142 only occurs in gNB2's 1112 cell (for example at UE2 1122) when gNB2 1112 is transmitting in the DL 1132. Hence, in order to mitigate either the DL CLI 1141 or the UL CLI 1142, UE1 1121 only needs to perform SBT for DL resources of gNB2 1112. If the SBT indicates that some resources are being used for DL transmission 1132 in a neighbour cell, UE1 1121 uses the second set of transmission parameter values at least for its UL resources that overlap with those DL resources. In order to determine whether transmissions in gNB2's 1112 cell are DL transmissions or UL transmissions, UE1 1121 may monitor for and attempt to decode DL reference signals (RS), such as DMRS, in neighbour cells.

If the DL RS cannot be detected with sufficient reliability, additional RS can be transmitted in the neighbour cell to improve performance in the serving cell. For example, whether or not the DL RS from the neighbour cell can be detected by a UE in the serving cell with sufficient reliability can be determined beforehand, for example through cell planning or by taking measurements in the deployment phase. If UEs cannot detect the DL reference signals from gNBs that could potentially cause CLI, those gNBs may be configured to send additional RS such that the UE can reliably detect whether the neighbour cell is transmitting in the UL or DL. Additionally or alternatively, if the UE is unable to determine the link direction (UL or DL) of the neighbour cell, it can request the neighbour cell to transmit additional RS. Referring to FIG. 11, UE1 1121 may send this request to gNB1 1111, where gNB1 1111 may then forward the request to gNB2 1112 via a backhaul interface.

In some examples, a node may utilise different transmission parameter values for different parts of the frequency resources used for the transmission. For example, a node may utilise the second set of transmission parameter values for frequency resources where CLI may occur. This may be understood by referring again to FIG. 12, where a UE may determine through SBT that CLI may occur at f₃ to f₄. Accordingly, the UE uses the second set of transmission parameter values for f₃ to f₄, but uses the first set of transmission parameter values for the remainder of the transmission (i.e. f₁ to f₃). For example, the UE may reduce its transmit power on those frequency resources f₃ to f₄, where CLI might occur, but not on other “safe” frequency resources. As another example, the UE may insert extra reference symbols to allow for interference cancellation on frequency resources f₃ to f₄, where CLI might occur, but not on other “safe” frequency resources.

Many cellular deployments are synchronised and support dynamic scheduling. When implementing SBT in such a system, if two nodes sense the channel (e.g. frequency resources) at the same time before transmitting, they may both observe the channel to be free and then both commence transmission at the same time. These colliding transmissions may create CLI. Furthermore, if a node senses the channel in one slot and determines the channel to be free, that sensing provides little information on whether the channel will be free in the following slot due to the dynamic nature of the scheduling. Accordingly, prior to initiating a DL transmission (e.g. a PDSCH) a node may transmit identifiable symbols before the DL transmission.

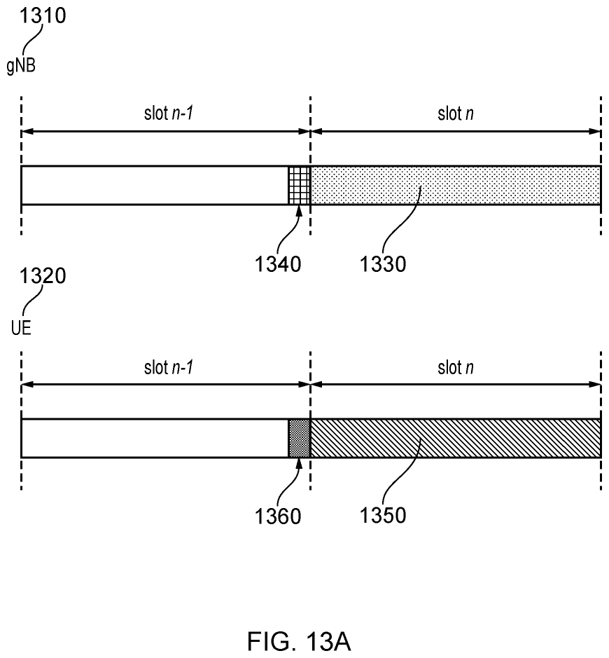

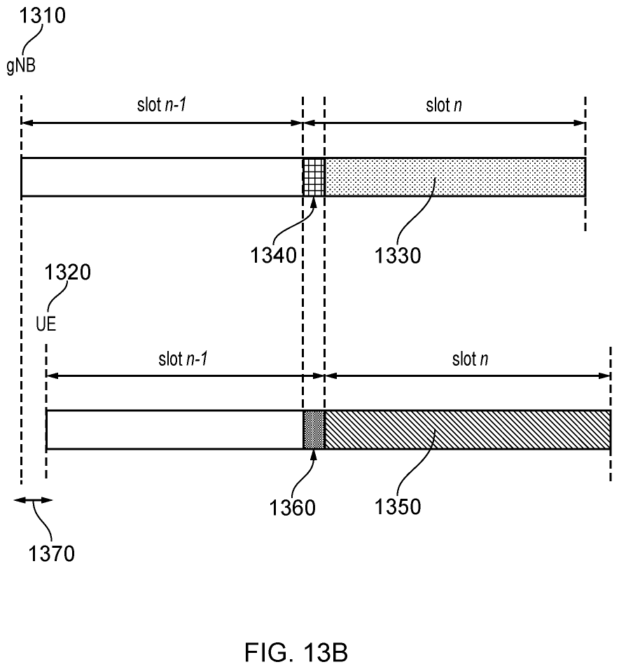

FIG. 13A shows an example implementation with a gNB 1310 and a UE 1320. The gNB transmits a DL transmission (e.g. a PDSCH 1330) in slot n, while the UE 1320 intends to transmit an UL transmission (e.g. a PUSCH 1350) in slot n. Prior to transmitting PDSCH 1330, gNB 1310 transmits one or more identifiable OFDM symbols 1340 which may be detected by UE 1320. The identifiable OFDM symbols 1340 may identify that the gNB 1310 will be transmitting a DL transmission in slot n. Before UE 1320 begins its PUSCH 1350 in slot n, UE 1320 performs SBT 1360 in slot n−1. UE 1320 detects the identifiable symbols 1340 of the gNB's 1310 scheduled PDSCH 1330 and determines that the PDSCH 1330 and PUSCH 1350 may cause CLI (i.e. the SBT test is failed). Accordingly, UE 1320 transmits the PUSCH 1350 using its second set of transmission parameter values, which may reduce or mitigate the effects of CLI, as discussed above.

Conversely, if there was no PDSCH 1330 from gNB 1310 in slot n, gNB 1310 may not transmit the identifiable OFDM symbols 1340. As such, when UE 1320 performs SBT 1360 in slot n−1, the UE 1320 determines that there is not PDSCH scheduled for slot n that would cause CLI with the PUSCH 1350 (i.e. the SBT test is passed). Accordingly, UE 1320 transmits the PUSCH 1350 with the first set of transmission parameter values. Transmitting a small number of OFDM symbols in slot n−1 (as shown in FIG. 13A) is not expected to impact the scheduling timeline of the gNB 1310 since the transmission of the identifiable OFDM symbols can occur in parallel to the DL transport and physical channel processing in the gNB. For example, with reference to FIG. 13A, the scheduling decision for slot n may have occurred at the start of slot n−1 and the physical channel processing of the PDSCH may have been performed over the whole of slot n−1. The processing of the identifiable OFDM symbol can take place in parallel with this physical channel processing and the final OFDM symbol of slot n−1 can be transmitted before the PDSCH in slot n is transmitted. It is noted that processing a single OFDM symbol is easier and takes less time than processing a whole physical channel, such as PDSCH.

Additionally or alternatively, the UL frame structure may be offset relative to the DL frame structure. By delaying the UL frame structure relative to the DL frame structure, a UE may perform SBT on a gNB's DL transmissions. FIG. 13B illustrates the offsetting of DL and UL frame structures to facilitate SBT. The UL frame structure is delayed by an offset 1370. This offset 1370 allows the UE 1320 to perform SBT 1360 in the first OFDM symbol of the (neighbour) gNB's 1310 DL PDSCH 1330 transmission. In

FIG. 13B, the first OFDM symbol of the PDSCH 1330 may identify the PDSCH 1330 transmission as DL. At the end of the UE's 1320 slot n−1, the UE 1320 performs SBT 1360. This SBT 1360 actually detects the first OFDM symbol of the gNB's 1310 PDSCH 1330 in the gNB's 1310 slot n. Since the UE 1320 has detected a PDSCH 1330 (and failed the SBT test), it determines that it should transmit with the second set of transmission parameter values.

When the UL frame timing is delayed with respect to the DL frame timing, the first OFDM symbol(s) of the PDSCH may in some cases identify the PDSCH as a DL transmission. For example, if the UE identifies a signal, if that signal contains OFDM symbols identifying that signal as DL, the UE uses the second transmission parameter values for its PUSCH. Conversely, if that signal does not contain OFDM symbols identifying that signal as DL, the UE understands the signal to be an UL signal. Since CLI generally does not occur when there are UL transmissions in the neighbour cell, the UE uses the first transmission parameter values for its PUSCH.

In some examples, the identifiable OFDM symbols discussed above may contain reference symbols. The reference symbols identify that the following slot will be used for PDSCH transmission. When these identifiable reference symbols are transmitted within a PDSCH, they can puncture the PDSCH transmission. Note that a “brute force puncturing” approach could be applied, where the UE is not aware that the reference symbol locations are punctured. This would facilitate operation with legacy UEs in the DL since the legacy UEs would decode the PDSCH according to known rules and may only suffer a DL decoding performance loss. This performance loss may be small if the number of RBs used for these reference symbols in the identifiable OFDM symbols is small.

Furthermore, in some examples, if a UE wishes to transmit an UL signal in slot n (see e.g. FIGS. 13A and/or 13B) and is transmitting UL in slot n−1 (not shown), the UE needs to cease transmitting its UL symbols in the OFDM symbol during which it has to perform SBT, since the UE is not able to both transmit and receive signals at the same time according to the half-duplex UE assumptions. Hence, a UE may interrupt (or puncture) an ongoing uplink transmission to perform SBT.

It will be appreciated that some traffic types (such as streaming services or voice) may not be dynamically scheduled or that there may be correlation between scheduling in adjacent time slots (such that there is a high probability that a UE will be scheduled in slot n if it had been scheduled in slot n−1). Hence, the techniques described above do not rely on the transmission of identifiable symbols and are applicable also for the case where the communications device monitors for legacy transmissions during a monitoring period.

Various signalling may be introduced to facilitate the above-described examples. For example, if the system wishes to optimise performance in the serving cell in the presence of CLI, semi-static signalling may indicate that the UE should use a more robust MCS. However, if the system wishes to minimise CLI in a neighbouring cell, semi-static signalling might indicate a combination of more robust MCS and lower power to be used. In this way, the network can indicate to other nodes how those nodes should respond when they detect other transmissions in the SBT process. In this way, a node may be aware of which transmission parameters should be altered, based on the SBT process.

Furthermore, as well as signalling which transmission parameters are changed between the first transmission parameter values and the second transmission parameter values, the UE may also need to know how the transmission parameters are changed based on the SBT outcome. Therefore, the UE may be provided with one or more scaling factors that the UE is to use in order to derive the second transmission parameter values based on the first transmission parameter values. For example, for an MCS transmission parameter the scaling factor may provide an MCS offset to apply to transmissions. As just one example, an offset of ‘3’ would mean that if the UE is scheduled with MCS_{N} according to the first transmission parameter values, it should apply MCS_{N-3} for the second transmission parameter values. If MCS_{N-3} leads to an out of bound MCS index, i.e. MCS<0, then the lowest MCS is used, i.e. if the offset is X, then MCS_{N-X}=max(MCS_{N-X}, MCS₀). In a similar manner, for a transmission power transmission parameter, the scaling factor may provide a factor by which the UE transmission power should be changed between first and second transmission parameter values. As just one example, an offset of ‘−2’ would indicate that if the first transmission parameter values indicated a power of P (dBm), the second transmission parameter values would relate to a power of P−2 (dBm).

Rather than being provided with a scaling factor as described above, nodes may be provided with tables indicating transmission parameter values for the second transmission parameter values based on the first transmission parameter values. For example, if the MCS transmission parameter is different between the first and second transmission parameter values, the node may utilise a table such as Table 1 below to determine what MCS value should be used for the second transmission parameter values. Such a table informs a node of what value of MCS to use based on the value utilised in the first set of transmission parameter values.

TABLE 1
An example table showing the relationship between MCS
values for different sets of transmission parameter values

| 1^{st} transmission parameter | 2^{nd} transmission parameter |
|---|---|
| values (MCS) | values (MCS) |
| 0 | Do not transmit |
| 1 | Do not transmit |
| 2 | Do not transmit |
| 3 | 0 |
| 4 | 1 |
| 5 | 2 |
| . . . | . . . |
| 13 | 10 |
| 14 | 10 |
| 15 | 10 |

Use of a table, such as Table 1, to describe the change in transmission parameters allows for a non-uniform/non-linear relationship between the first and second transmission parameters. For example, in the above table, an MCS offset of ‘3’ is applied when the 1^{st} transmission parameter is 3, 4, 5, . . . 13, but wider MCS offsets are applied when the 1^{st} transmission parameter is 14 or 15. Note that Table 1 above also includes some rows labelled “Do not transmit” in the second transmission parameter values. For these rows, it may not be possible to operate with a reliable second transmission parameter and in these cases, it may be preferable that the UE does not transmit at all, as this would minimise CLI that the UE transmission would have caused. In some cases, if a table is not signalled for a given transmission parameter, the value of the transmission parameter in the second set of transmission parameter values may be the same as in the first set of transmission parameter values.

In some cases, a node may be provided with multiple tables for a given transmission parameter. For example, a UE may receive multiple tables indicating possible values for a transmission parameter for different transmission parameter value sets. For example, two or more MCS index tables can be defined, where the first transmission parameter values use a first MCS index table and a second transmission parameter values use a second MCS index table. For example, for a PUSCH, the first transmission parameter values may use the first MCS index table, which may be used for high spectral efficiency but less robust transmissions such as eMBB, and the second transmission parameter values can use the second MCS index table, which may be used for more robust but less spectrally efficient transmission such as URLLC. The first and second MCS index tables may in some cases correspond to known MCS index tables [3]. It should be appreciated that other MCS index tables can be used and this embodiment is not restricted to only first and second MCS index tables.

According to some examples, instead of there being a defined relationship between the first and second transmission parameter values, a default second set of transmission parameter values may be semi-statically signalled to a UE. That is, if the UE detects another transmission in the SBT process (i.e. the SBT test is failed), the UE would apply this default second set of transmission parameter values instead of the first set of transmission parameter values. While this example is less dynamic than some other examples, it simplifies operation and the structure of the signalling messages. Note that if the UE moves to a location with different propagation conditions, the default second set of transmission parameter values may be updated. For example, if the UE moves to a location where the default second set of transmission parameter values becomes less robust than the first set of transmission parameter values, the default second set of transmission parameter values can be updated.

In some cases, the network may semi-statically signal multiple second sets of transmission parameter values. The UE may then choose which second set of transmission parameter values to apply based on a criterion. For example, The UE may choose which second set of transmission parameter values to use based on RSRP measurements of the serving cell. If the RSRP is low, the UE may use a more robust second set of transmission parameter values. If the RSRP is high, the UE would use a less robust set of transmission parameter values. This example allows a UE to choose an appropriate set of transmission parameter values such that its transmission can be robustly decoded at its serving gNB. Additionally or alternatively, a UE may choose which of the second sets of transmission parameter values to use based on neighbour cell measurements. For example, if neighbour cell SBT measurements indicate that the UE could create significant interference in the neighbour cell, the UE could use a set of second transmission parameter values with lower transmission power, such that less CLI is created in the neighbour cell.

When a UE is scheduled by its serving gNB, a DCI may be used to indicate two sets of transmission parameter values to used. For example, the DCI may indicate a first set of transmission parameter values to be used if the SBT test is passed, and a second set of transmission parameter values to be used if the SBT test is failed. In some cases, the second set of transmission parameter values may be incomplete (i.e. the second set of transmission parameter values may not include a value for one or more transmission parameters). In such a scenario, the UE may use the corresponding value(s) from the first set of transmission parameter values for the incomplete second set of transmission parameter values. For example, if the first set of transmission parameter values includes {power₁, MCS₁, physical_resources₁} and the second set of transmission parameter values provided to the UE only contains a power₂ parameter, the UE would use parameters {power₂, MCS₁, physical_resources₁} if the SBT test was failed.

In some cases, such as the examples of FIGS. 13A and 13B discussed above, it may be beneficial for a UE to know specific OFDM symbols on which SBT can/should be performed. For instance, in the example of FIG. 13A, the UE may need to know the properties of any identifiable OFDM symbols 1340 that are transmitted prior to a gNB's PUSCH slot. The properties can, for example, include the number of OFDM symbols that the gNB transmits before a PDSCH, and sequences applied to any reference symbols transmitted within those identifiable symbols. Returning to FIG. 13B, the UE may need to know the frame offset 1370 between UL and DL frames structures. Knowing the offset, the UE may be able to perform SBT 1360 during the time of the offset. However, in some cases the offset 1370 may not be signalled to the UE and the gNB may instead signal the OFDM symbols that the UE may utilise for SBT (in a similar manner to the example of FIG. 13A above). That is, the gNB may take into account the offset when signalling the OFDM symbols to the UE, and as such the UE may not need to be aware of the offset in order to perform SBT.

As discussed above, for PUSCH transmission a UE determines which transmission parameter values to use (e.g. which set of transmission parameter values to use) based on the outcome of the SBT process. Accordingly, a gNB receiving the PUSCH from the UE may not be aware of the transmission parameters used. The gNB therefore generally has to blind decode the PUSCH according to the possible sets of transmission parameter values. However, the blind decoding load can be decreased by firstly attempting to decode with the most likely set of transmission parameters. Therefore, in some cases the gNB may perform SBT prior to decoding the UE's PUSCH transmission. Then, if the gNB detects a DL transmission from another gNB that causes CLI, it attempts to decode the UE's transmission using the second set of transmission parameter values, as the gNB determines that these are the transmission parameter values that the UE likely used. If this decoding fails, the gNB attempts to decode the PUSCH using the first set of transmission parameter values. Similarly, if the gNB does not detect a DL transmission from another gNB, the gNB attempts to decode the PUSCH using the first set of transmission parameter values. If this decoding fails, the gNB then attempts to decode the PUSCH using the second set of transmission parameter values.

In some examples, a UE may be in a location that is close to an aggressor gNB, such as gNB2 1112 in FIG. 11. The UE SBT process in the UE would then trigger the UE to use the second set of transmission parameter values. However, gNB2 1112 may be geographically far away from the UE's serving gNB i.e. gNB1 1111 in FIG. 11. Therefore, gNB2's 1112 DL transmission to UE2 1122 may not cause CLI 1141 at gNB1 1111. UE1 1121 may therefore use the second set of transmission parameter values unnecessarily. Accordingly, in some examples a serving gNB (victim gNB) may signal a list of concerning neighbour cells (aggressor gNBs) to UEs in the cell. When the UE performs SBT, the UE determines whether one or more of the concerning neighbour cells in the list is transmitting. If so, the UE transmits using the second set of transmission parameter values. Otherwise, the UE transmits using the first set of transmission parameter values. The UE may determine the identity of the neighbour cells in the SBT process by various means, including detecting DMRS or Synchronization Signal Block (SSB) sequences/signals/channels from the neighbour cells, where such signals or sequences may be unique (in a geographic area) to those neighbour cells.

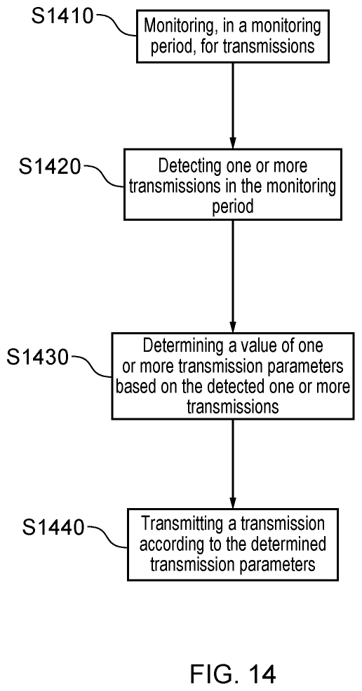

FIG. 14 illustrates a method for performing SBT and selecting transmission parameters based on the SBT measurement. This method may be performed by a communications device or an infrastructure equipment. At step S1410, the method includes a step of monitoring for transmissions in a monitoring period. The monitoring period may be prior to a transmission by the device. For example, if the performing device is a communications device, the monitoring period may be prior to an uplink transmission by the communications device, and if the device is an infrastructure equipment the monitoring period may be prior to a downlink transmission by the infrastructure equipment.

At step S1420, the device detects one or more transmissions in the monitoring period. For example, the device may measure may measure an energy level of the one or more transmissions to determine if the energy level is above a predetermined threshold. At step S1430, based on the detected one or more transmissions, the device determines a value of one or more transmission parameters. For example, the device may pick a set of values for one or more transmission parameters based on the result of the detection. A step S1440, the device transmits the transmission according to the determined transmission parameters.

Accordingly, from one perspective there has been described methods, communications device, infrastructure equipment and circuitry for performing a sense before transmission (SBT) process before a transmission and adjusting transmission parameters based on the SBT process. A device monitors for transmissions in a monitoring period prior to its own transmission and if it detects one or more transmissions in the monitoring period adjusts the transmission parameters for its own transmission to reduce a level of CLI at another device.

Further examples of feature combinations taught by the present disclosure are set out in the following numbered clauses:
1. A method for a communications device configured to transmit signals to and/or to receive signals from an infrastructure equipment of a wireless communications network via a wireless radio interface provided by the wireless communications network, the method comprising:
   monitoring, in a monitoring period, for one or more transmissions prior to an uplink transmission to the infrastructure equipment;
   detecting one or more transmissions in the monitoring period;
   based on the detected one or more transmissions, determining a value of one or more transmission parameters for the uplink transmission; and
   transmitting the uplink transmission according to the determined value of the one or more transmission parameters.
2. The method according to clause 1, wherein detecting the value one or more transmissions in the monitoring period comprises detecting a reception energy of the detected one or more transmissions at the communications device, and
   wherein determining the value of the one or more transmission parameters for the uplink transmission is based on determining whether the reception energy of the detected one or more transmissions is above a predetermined threshold.
3. The method according to clause 1 or clause 2, wherein determining the value of the one or more transmission parameters for the uplink transmission comprises selecting a set of transmission parameter values from a plurality of predetermined sets of transmission parameter values.
4. The method according to any preceding clause, wherein the one or more transmission parameters include a modulation and coding scheme for the uplink transmission, wherein the determining a value of one or more transmission parameters for the uplink transmission comprises determining to use a first modulation and coding scheme or a second modulation and coding scheme for the uplink transmission, based on the detected one or more transmissions.
5. The method according to any preceding clause, wherein the one or more transmission parameters include a transmission power for the uplink transmission, wherein the determining a value of one or more transmission parameters for the uplink transmission comprises determining to use a first transmission power or a second transmission power for the uplink transmission, based on the detected one or more transmissions.
6. The method according to any preceding clause, wherein the one or more transmission parameters include a set of physical resources for the uplink transmission.
7. The method according to clause 6, wherein the set of physical resources comprises a set of frequency domain resources for the uplink transmission, wherein the determining a value of one or more transmission parameters for the uplink transmission comprises determining to use a first set of frequency domain resources or a second set of frequency domain resources for the uplink transmission, based on the detected one or more transmissions.
8. The method according to any preceding clause, wherein the one or more transmission parameters include a set of reference symbols to be applied to the uplink transmission.
9. The method according to clause 8, wherein the set of reference symbols to be applied to the uplink transmission includes a demodulation reference signal, wherein the determining a value of one or more transmission parameters for the uplink transmission comprises determining a number of demodulation reference signals to include with the uplink transmission, based on the detected one or more transmissions.
10. The method according to clause 8 or 9, wherein the set of reference symbols to be applied to the uplink transmission includes a set of interference cancellation reference symbols for the infrastructure equipment or another communications device of the wireless communications network to perform interference cancellation.
11. The method according to any preceding clause, wherein the one or more transmission parameters include a number of multiple input multiple output (MIMO) layers to be applied to the uplink transmission.
12. The method according to any preceding clause, wherein the one or more transmission parameters include a number of code block groups (CBGs) to be applied to the uplink transmission.
13. The method according to any preceding clause, wherein the uplink transmission is one of a PUSCH, PUCCH, SRS and PRACH.
14. The method according to clause 13, wherein the uplink transmission is a PUCCH and the one or more transmission parameters include a PUCCH format to be applied to the uplink transmission.
15. The method according to clause 13 or 14, wherein the uplink transmission is a PUCCH and the one or more transmission parameters include a frequency hopping parameter to be applied to the uplink transmission.
16. The method according to clause 13, wherein the uplink transmission is an SRS and the one or more transmission parameters include an SRS configuration to be applied to the uplink transmission.
17. The method according to clause 13, wherein the uplink transmission is a PRACH and the one or more transmission parameters include a PRACH format to be applied to the uplink transmission.
18. The method according to clause 13 or 17, wherein the uplink transmission is a PRACH and the one or more transmission parameters include a PRACH power ramping step size to be applied to the uplink transmission.
19. The method according to any preceding clause, wherein monitoring for the one or more transmissions comprises monitoring frequency resources associated with the uplink transmission.
20. The method according to clause 19, wherein monitoring frequency resources associated with the uplink transmission comprises monitoring a frequency sub-band available for the uplink transmission.
21. The method according to clause 20, wherein monitoring frequency resources associated with the uplink transmission further comprises monitoring a neighbour frequency sub-band, wherein the neighbour frequency sub-band is adjacent to the frequency sub-band available for the uplink transmission in a frequency domain.
22. The method according to any of clauses 19-21, wherein monitoring frequency resources associated with the uplink transmission comprises monitoring a plurality of sets of frequency resources, wherein determining the value of one or more transmission parameters for the uplink transmission comprises determining a set of frequency resources of the plurality of sets of frequency resources on which to transmit the uplink transmission.
23. The method according to any of clauses 19-22, wherein monitoring frequency resources associated with the uplink transmission comprises:
   identifying a first set of frequency resources associated with the uplink transmission;
   determining an allocation of the first set of frequency resources by another infrastructure equipment of the wireless communications network to one of: uplink transmissions, downlink transmissions, or as flexible frequency resources;
   based on determining the allocation of the first set of frequency resources by the other infrastructure equipment, monitoring the first set of frequency resources.
24. The method according to clause 23, wherein determining an allocation of the first set of frequency resources by another infrastructure equipment comprises receiving, from the infrastructure equipment, the allocation of the first set of frequency resources by the other infrastructure equipment.
25. The method according to clause 23 or 24, wherein determining an allocation of the first set of frequency resources by another infrastructure equipment comprises monitoring the first set of frequency resources for one or more reference signals from the other infrastructure equipment.
26. The method according to clause 25, further comprising:
   determining that the communications device is unable to determine the allocation of the first set of frequency resources by another infrastructure equipment;
   transmitting a request for the other infrastructure equipment to transmit one or more additional reference signals; and
   monitoring the first set of frequency resources for the one or more additional reference signals from the other infrastructure equipment.
27. The method according to any of clauses 19-26, further comprising:
   detecting the one or more transmissions in the monitoring period at a first set of frequency resources of the monitored frequency resources;
   selecting a first set of transmission parameter values for the first set of frequency resources associated with the uplink transmission;
   selecting a second set of transmission parameter values for a second set of frequency resources associated with the uplink transmission; and
   transmitting the uplink transmission using the first and second sets of frequency resources according to the respective first and second sets of transmission parameter values.
28. The method according to any preceding clause, wherein the uplink transmission is transmitted in a first slot, and wherein the monitoring period is in a second slot immediately preceding the first slot.
29. The method according to clause 28, wherein the one or more transmissions detected in the monitoring period in the second slot includes an identification of a scheduled downlink transmission by another infrastructure equipment of the wireless communications network, wherein the downlink transmission is scheduled for the first slot.
30. The method according to clause 29, further comprising:
   receiving, from the infrastructure equipment, one or more properties of the detected identification.
31. The method according to clause 29 or 30, wherein the identification of the downlink transmission by the other infrastructure equipment includes one or more reference symbols.
32. The method according to any of clauses 29-31, wherein a timing of the first and second slots for the communications device is configured to be offset relative to corresponding first and second slots for the other infrastructure equipment.
33. The method according to clause 32, further comprising:
   receiving, from the infrastructure equipment, an indication of the offset of the first and second slots for the communications device relative to the corresponding first and second slots for the other infrastructure equipment.
34. The method according to any of clauses 29-33, wherein the identification of the downlink transmission by the other infrastructure equipment is included within initial orthogonal frequency-division multiplexing (OFDM) symbols of the downlink transmission.
35. The method according to any preceding clause, wherein monitoring for one or more transmissions comprises interrupting an ongoing uplink transmission to monitor for the one or more transmissions in the monitoring period.
36. The method according to any preceding clause, further comprising:
   receiving, from the infrastructure equipment, an indication of transmission parameters to be adjusted for the uplink transmission based on the detected one or more transmissions,
   wherein the communications device determines the value of the one or more transmission parameters for the uplink transmission based on the detected one or more transmissions and the received indication.
37. The method according to any preceding clause, further comprising:
   receiving, from the infrastructure equipment, an indication of a plurality of predetermined transmission parameters values to be utilised for the uplink transmission based on the detected one or more transmissions,
   wherein the communications device determines the value of the one or more transmission parameters for the uplink transmission based on the detected one or more transmissions and the received indication of the plurality of predetermined transmission parameters values.
38. The method according to clause 37, wherein receiving the indication of the plurality of predetermined transmission parameters values comprises receiving a first value for a first transmission parameter and one or more offset values indicating a modification to the first value for the first transmission parameters,
   wherein the communications device determines the value of the one or more transmission parameters for the uplink transmission based on the detected one or more transmissions, the first value for the first transmission parameter and the one or more offset values.
39. The method according to clause 37, wherein receiving the indication of the plurality of predetermined transmission parameters values comprises receiving one or more tables for one or more transmission parameters, wherein each of the one or more tables indicates a plurality of transmission parameter values for one or more transmission parameters for the uplink transmission, based on the detected one or more transmissions.
40. The method according to clause 39, wherein receiving the one or more tables comprises receiving a plurality of tables for a first transmission parameter, wherein each of the plurality of tables indicates a plurality of transmission parameter values for the first transmission parameter,
   wherein the communications device determines the value of the first transmission parameter by referring to a particular table of the plurality of tables based on the detected one or more transmissions.
41. The method according to any of clauses 37-40, wherein receiving the indication of the plurality of predetermined transmission parameters values comprises receiving a plurality of sets of transmission parameter values, and wherein the communications device determines which of the plurality of sets of transmission parameter values to use for the uplink transmission based on the detected one or more transmissions.
42. The method according to clause 41, wherein the communications device determines which of the plurality of sets of transmission parameter values to use for the uplink transmission based on a reference signal received power (RSRP) measurement performed by the communications device for the infrastructure equipment.
43. The method according to clause 41 or 42, wherein the communications device determines which of the plurality of sets of transmission parameter values to use for the uplink transmission based on a measurement of one or more interference indicators associated with another infrastructure equipment of the wireless communications network.
44. The method according to any of clauses 41-43, wherein the plurality of sets of transmission parameter values includes a first set of transmission parameter values, and a second set of transmission parameter values, the second set of transmission parameter values including values for a subset of the transmission parameters of the first set of transmission parameter values,
   wherein the communications device, when determining to use the second set of transmission parameter values for the uplink transmission, determines to use the second set of transmission parameter values for the subset of the transmission parameters, and to use transmission parameter values from the first set of transmission parameter values for transmission parameters not included in the subset of the transmission parameters.
45. The method according to any of clauses 37-44, wherein the indication of the plurality of predetermined transmission parameters values is included in a downlink control information message.
46. The method according to any preceding clause, further comprising:
   receiving, from the infrastructure equipment, an indication of the monitoring period in which the communications device monitors for one or more transmissions.
47. The method according to any preceding clause, further comprising:
   receiving, from the infrastructure, a list of one or more aggressor infrastructure equipments; and
   wherein determining the value of the one or more transmission parameters for the uplink transmission is based on a determination of whether the detected one or more transmissions originate from an aggressor infrastructure equipment of the list of the one or more aggressor infrastructure equipments.
48. A communications device comprising:
   a transceiver configured to transmit signals to and/or to receive signals from an infrastructure equipment of a wireless communications network via a wireless radio interface provided by the wireless communications network; and
   a controller configured with the transceiver to:
      monitor, in a monitoring period, for one or more transmissions prior to an uplink transmission to the infrastructure equipment;
      detect one or more transmissions in the monitoring period;
      based on the detected one or more transmissions, determine a value of one or more transmission parameters for the uplink transmission; and
      transmit the uplink transmission according to the determined value of the one or more transmission parameters.
49. Circuitry for a communications device, the circuitry comprising:
   transceiver circuitry configured to transmit signals to and/or to receive signals from an infrastructure equipment of a wireless communications network via a wireless radio interface provided by the wireless communications network; and
   controller circuitry configured with the transceiver circuitry to:
      monitor, in a monitoring period, for one or more transmissions prior to an uplink transmission to the infrastructure equipment;
      detect one or more transmissions in the monitoring period;
      based on the detected one or more transmissions, determine a value of one or more transmission parameters for the uplink transmission; and
      transmit the uplink transmission according to the determined value of the one or more transmission parameters.
50. A method for an infrastructure equipment configured to transmit signals to and/or to receive signals from a communications device of a wireless communications network via a wireless radio interface provided by the wireless communications network, the method comprising:
   monitoring, in a monitoring period, for one or more transmissions prior to a downlink transmission to the communications device;
   detecting one or more transmissions in the monitoring period;
   based on the detected one or more transmissions, determining a value of one or more transmission parameters for the downlink transmission; and
   transmitting the downlink transmission according to the determined value of the one or more transmission parameters.
51. The method according to clause 50, wherein detecting the value one or more transmissions in the monitoring period comprises detecting a reception energy of the detected one or more transmissions at the infrastructure equipment, and
wherein determining the value of the one or more transmission parameters for the downlink transmission is based on determining whether the reception energy of the detected one or more transmissions is above a predetermined threshold.
52. The method according to clause 50 or clause 51, wherein determining the value of the one or more transmission parameters for the downlink transmission comprises selecting a set of transmission parameter values from a plurality of predetermined sets of transmission parameter values.
53. The method according to any of clauses 50-52, wherein the one or more transmission parameters include one or more of: a modulation and coding scheme for the downlink transmission, a transmission power for the downlink transmission, a set of physical resources for the downlink transmission, a set of reference symbols to be applied to the downlink transmission, a number of multiple input multiple output (MIMO) layers to be applied to the downlink transmission, and a number of code block groups (CBGs) to be applied to the downlink transmission.
54. The method according to any of clauses 50-53, wherein the downlink transmission is one of a PDSCH, SPS PDSCH or PDCCH.
55. The method according to any of clauses 50-54, wherein monitoring for the one or more transmissions comprises monitoring frequency resources associated with the downlink transmission.
56. The method according to clause 55, wherein monitoring frequency resources associated with the downlink transmission comprises monitoring a frequency sub-band available for the downlink transmission.
57. The method according to clause 56, wherein monitoring frequency resources associated with the downlink transmission further comprises monitoring a neighbour frequency sub-band, wherein the neighbour frequency sub-band is adjacent to the frequency sub-band available for the downlink transmission in a frequency domain.
58. The method according to any of clauses 55-57, wherein monitoring frequency resources associated with the downlink transmission comprises monitoring a plurality of sets of frequency resources, wherein determining the value of one or more transmission parameters for the downlink transmission comprises determining a set of frequency resources of the plurality of sets of frequency resources on which to transmit the downlink transmission.
59. The method according to any of clauses 55-58, wherein monitoring frequency resources associated with the downlink transmission comprises:
   identifying a first set of frequency resources associated with the downlink transmission;
   determining an allocation of the first set of frequency resources by another infrastructure equipment of the wireless communications network to one of: uplink transmissions, downlink transmissions, or as flexible frequency resources;
   based on determining the allocation of the first set of frequency resources by the other infrastructure equipment, monitoring the first set of frequency resources.
60. The method according to clause 59, wherein determining an allocation of the first set of frequency resources by another infrastructure equipment comprises receiving, from the infrastructure equipment, the allocation of the first set of frequency resources by the other infrastructure equipment.
61. The method according to clause 59 or 60, wherein determining an allocation of the first set of frequency resources by another infrastructure equipment comprises monitoring the first set of frequency resources for one or more reference signals from the other infrastructure equipment.
62. The method according to clause 61, further comprising:
   determining that the communications device is unable to determine the allocation of the first set of frequency resources by another infrastructure equipment;
   transmitting a request for the other infrastructure equipment to transmit one or more additional reference signals; and
   monitoring the first set of frequency resources for the one or more additional reference signals from the other infrastructure equipment.
63. The method according to any of clauses 55-62, further comprising:
   detecting the one or more transmissions in the monitoring period at a first set of frequency resources of the monitored frequency resources;
   selecting a first set of transmission parameter values for the first set of frequency resources associated with the downlink transmission;
   selecting a second set of transmission parameter values for a second set of frequency resources associated with the downlink transmission; and
   transmitting the downlink transmission using the first and second sets of frequency resources according to the respective first and second sets of transmission parameter values.
64. The method according to any of clauses 55-63, wherein the downlink transmission is transmitted in a first slot, and wherein the monitoring period is in a second slot immediately preceding the first slot.
65. The method according to clause 64, wherein the one or more transmissions detected in the monitoring period in the second slot includes an identification of a scheduled downlink transmission by another infrastructure equipment of the wireless communications network, wherein the downlink transmission is scheduled for the first slot.
66. The method according to clause 65, further comprising:
   receiving, from the other infrastructure equipment, one or more properties of the detected identification.
67. The method according to clause 65 or 66, wherein the identification of the downlink transmission by the other infrastructure equipment includes one or more reference symbols.
68. The method according to any of clauses 65-67, wherein a timing of the first and second slots for the communications device is configured to be offset relative to corresponding first and second slots for the other infrastructure equipment.
67. The method according to clause 67 or 68, wherein the identification of the downlink transmission by the other infrastructure equipment is included within initial orthogonal frequency-division multiplexing (OFDM) symbols of the downlink transmission.
68. An infrastructure equipment comprising:
   a transceiver configured to transmit signals to and/or to receive signals from a communications device of a wireless communications network via a wireless radio interface provided by the wireless communications network; and
   a controller configured with the transceiver to:
      monitor, in a monitoring period, for one or more transmissions prior to a downlink transmission to the communications device;
      detect one or more transmissions in the monitoring period;
      based on the detected one or more transmissions, determine a value of one or more transmission parameters for the downlink transmission; and
      transmit the downlink transmission according to the determined value of the one or more transmission parameters.
69. Circuitry for an infrastructure equipment, the circuitry comprising:
   transceiver circuitry configured to transmit signals to and/or to receive signals from a communications device of a wireless communications network via a wireless radio interface provided by the wireless communications network; and
   controller circuitry configured with the transceiver circuitry to:
      monitor, in a monitoring period, for one or more transmissions prior to a downlink transmission to the communications device;
      detect one or more transmissions in the monitoring period;
      based on the detected one or more transmissions, determine a value of one or more transmission parameters for the downlink transmission; and
      transmit the downlink transmission according to the determined value of the one or more transmission parameters.

### REFERENCES

[1] Holma H. and Toskala A, “LTE for UMTS OFDMA and SC-FDMA based radio access”, John Wiley and Sons, 2009.
[2] RP-213591, “New SI: Study on evolution of NR duplex operation,” CMCC, RAN #94e
[3] TS38.214, “NR: Physical layer procedures for data (Release 17),” v17.1.0

1. A method for a communications device configured to transmit signals to and/or to receive signals from an infrastructure equipment of a wireless communications network via a wireless radio interface provided by the wireless communications network, the method comprising:
monitoring, in a monitoring period, for one or more transmissions prior to an uplink transmission to the infrastructure equipment;
detecting one or more transmissions in the monitoring period;
based on the detected one or more transmissions, determining a value of one or more transmission parameters for the uplink transmission; and
transmitting the uplink transmission according to the determined value of the one or more transmission parameters.

2. The method according to claim 1, wherein detecting the value one or more transmissions in the monitoring period comprises detecting a reception energy of the detected one or more transmissions at the communications device, and
wherein determining the value of the one or more transmission parameters for the uplink transmission is based on determining whether the reception energy of the detected one or more transmissions is above a predetermined threshold.

3. The method according to claim 1, wherein determining the value of the one or more transmission parameters for the uplink transmission comprises selecting a set of transmission parameter values from a plurality of predetermined sets of transmission parameter values.

4. The method according to claim 1, wherein the one or more transmission parameters include one or more of: a modulation and coding scheme for the uplink transmission, a transmission power for the uplink transmission, a set of physical resources for the uplink transmission, a set of reference symbols to be applied to the uplink transmission, a number of multiple input multiple output (MIMO) layers to be applied to the uplink transmission, and a number of code block groups (CBGs) to be applied to the uplink transmission.

5. The method according to claim 1, wherein the uplink transmission is one of a PUSCH, PUCCH, SRS and PRACH.

6. The method according to claim 1, wherein monitoring for the one or more transmissions comprises monitoring frequency resources associated with the uplink transmission.

7. The method according to claim 6, wherein monitoring frequency resources associated with the uplink transmission comprises:
identifying a first set of frequency resources associated with the uplink transmission;
determining an allocation of the first set of frequency resources by another infrastructure equipment of the wireless communications network to one of: uplink transmissions, downlink transmissions, or as flexible frequency resources;
based on determining the allocation of the first set of frequency resources by the other infrastructure equipment, monitoring the first set of frequency resources.

8. The method according to claim 6, further comprising:
detecting the one or more transmissions in the monitoring period at a first set of frequency resources of the monitored frequency resources;
selecting a first set of transmission parameter values for the first set of frequency resources associated with the uplink transmission;
selecting a second set of transmission parameter values for a second set of frequency resources associated with the uplink transmission; and
transmitting the uplink transmission using the first and second sets of frequency resources according to the respective first and second sets of transmission parameter values.

9. The method according to claim 1, wherein the uplink transmission is transmitted in a first slot, and wherein the monitoring period is in a second slot immediately preceding the first slot.

10. The method according to claim 9, wherein the one or more transmissions detected in the monitoring period in the second slot includes an identification of a scheduled downlink transmission by another infrastructure equipment of the wireless communications network, wherein the downlink transmission is scheduled for the first slot.

11. The method according to claim 10, wherein the identification of the downlink transmission by the other infrastructure equipment includes one or more reference symbols.

12. The method according to claim 10, wherein a timing of the first and second slots for the communications device is configured to be offset relative to corresponding first and second slots for the other infrastructure equipment.

13. The method according to claim 10, wherein the identification of the downlink transmission by the other infrastructure equipment is included within initial orthogonal frequency-division multiplexing (OFDM) symbols of the downlink transmission.

14. The method according to claim 1, wherein monitoring for one or more transmissions comprises interrupting an ongoing uplink transmission to monitor for the one or more transmissions in the monitoring period.

15. The method according to claim 1, further comprising:
receiving, from the infrastructure equipment, an indication of transmission parameters to be adjusted for the uplink transmission based on the detected one or more transmissions,
wherein the communications device determines the value of the one or more transmission parameters for the uplink transmission based on the detected one or more transmissions and the received indication.

16. The method according to claim 1, further comprising:
receiving, from the infrastructure equipment, an indication of a plurality of predetermined transmission parameters values to be utilised for the uplink transmission based on the detected one or more transmissions,
wherein the communications device determines the value of the one or more transmission parameters for the uplink transmission based on the detected one or more transmissions and the received indication of the plurality of predetermined transmission parameters values.

17.-19. (canceled)

20. The method according to claim 1, further comprising:
receiving, from the infrastructure equipment, an indication of the monitoring period in which the communications device monitors for one or more transmissions.

21. The method according to claim 1, further comprising:
receiving, from the infrastructure, a list of one or more aggressor infrastructure equipments; and
wherein determining the value of the one or more transmission parameters for the uplink transmission is based on a determination of whether the detected one or more transmissions originate from an aggressor infrastructure equipment of the list of the one or more aggressor infrastructure equipments.

22. A communications device comprising:
a transceiver configured to transmit signals to and/or to receive signals from an infrastructure equipment of a wireless communications network via a wireless radio interface provided by the wireless communications network; and
a controller configured with the transceiver to:
monitor, in a monitoring period, for one or more transmissions prior to an uplink transmission to the infrastructure equipment;
detect one or more transmissions in the monitoring period;
based on the detected one or more transmissions, determine a value of one or more transmission parameters for the uplink transmission; and
transmit the uplink transmission according to the determined value of the one or more transmission parameters.

23. (canceled)

24. A method for an infrastructure equipment configured to transmit signals to and/or to receive signals from a communications device of a wireless communications network via a wireless radio interface provided by the wireless communications network, the method comprising:
monitoring, in a monitoring period, for one or more transmissions prior to a downlink transmission to the communications device;
detecting one or more transmissions in the monitoring period;
based on the detected one or more transmissions, determining a value of one or more transmission parameters for the downlink transmission; and
transmitting the downlink transmission according to the determined value of the one or more transmission parameters.

25.-26. (canceled)
